(19) United States
(12) Patent Application Publication
(10) Pub. No.: US 2018/0200649 A1
(43) Pub. Date: Jul. 19, 2018

(54) A LIQUID FILTER, AND A LIQUID FILTRATION APPARATUS USING THE LIQUID FILTER

(71) Applicant: NABELL CORPORATION, Iga-shi, Mie (JP)

(72) Inventors: Norio Nagai, Iga-shi, Mie (JP); Kohji Tsukamoto, Iga-shi, Mie (JP); Masayuki Maki, Iga-shi, Mie (JP)

(21) Appl. No.: 15/741,198

(22) PCT Filed: May 11, 2017
(86) PCT No.: PCT/JP2017/017806

§ 371 Date: Dec. 29, 2017

(30) Foreign Application Priority Data
May 12, 2016 (JP) 2016-095749

(51) Int. Cl. B01D 27/06; B01D 27/08; B01D 29/07; B01D 35/02

(52) U.S. Cl. CPC B01D 27/06; B01D 27/08; B01D 46/521; B01D 35/02; B01D 29/07

(57) ABSTRACT

[Subject] To provide a novel liquid filter allowed for cleaning of adhered, foreign matter, and reusable after cleaned up,

[Solving Means] A liquid filter has a liquid-receiving space 3d formed at the center; a plurality of ridge parts 3a vertically juxtaposed so as to be exposed individually to the front, back, left side and right side; and a plurality of valley parts 3b each formed on the sides opposite to the individual positions of formation of the ridge parts 3a the liquid filter can be unfolded from a folded state into a rectangular sheet body 5, and the sheet body 5 in the folded state has its left end and right end overlapped.

### TECHNICAL FIELD

This invention relates to a liquid filter that is used, while housed in a filter case, for removing sludge or other foreign matters contained in a liquid such as oil, and a liquid filtration apparatus using the liquid filter, and in particular relates to a liquid filter formed in a tubular shape by folding a sheet so as to alternately make ridge parts and valley parts, and a liquid filtration apparatus using the liquid filter.

### BACKGROUND ART

Miscellaneous types or styles of liquid filters have been proposed. A liquid filter disclosed, for example, in JP-U-H06-726101 (Patent Literature 1) is a pleated cloth folded up from a rectangular cloth so as to alternately form ridge parts and valley parts, and is given as a filter element as a whole, with an upper disk fixed to the top edge of the liquid filter, and with a lower disk fixed to the lower portion of the same. The liquid filter has the ridge parts and the valley parts that are formed on the inner circumferential side and the outer circumferential side, with the longitudinal direction of the ridge parts or the valley part aligned to the height direction of the liquid filter as a whole. The thus formed filter element is housed in a casing. When a liquid comes in an inflow space formed at the center of the liquid filter and then passes through the liquid filter, sludge or other foreign matter having been contained in the liquid is trapped on the inner circumferential face of the liquid filter, and the filtrate freed from the foreign matter is output outside the liquid filter.

A liquid filter disclosed typically in JP-U-H05-56205 (Patent Literature 2) is formed into a bellows shape, having formed therein a liquid inflow space into which a liquid flows. The liquid filter has a large number of ridge parts formed on the outer circumference thereof. The longitudinal direction of these ridge parts lies in the direction orthogonal to the height direction of the liquid filter (or, circumferential direction). Again in this liquid filter, any foreign matter having been contained in the liquid, that comes into the inflow space is trapped on the inner circumferential face of the liquid filter, and the filtrate freed from the foreign matter is output outside the liquid filter.

### PATENT LITERATURE

### Patent Literature

[Patent Literature 1] JP-U-H06-72610

[Patent Literature 2] JP-U-H05-56205

### SUMMARY OF THE INVENTION

### Technical Problem

Since, however, in the liquid filter and the liquid filtration apparatus using the liquid filter disclosed in Patent Literature 1, the liquid filter per se is fixed to the upper disk and the lower disk, so that it is all impossible to take the liquid filter out from the casing, to unfold the liquid filter, to clean off the foreign matter adhered to the inner face, to re-fold the cleaned liquid filter, and to reuse it as a filter element. The same will apply to the liquid filter disclosed in Patent Literature 2. Even if the liquid filter could toe taken out from the casing, it is very difficult to remove the foreign matter adhered or trapped on the inner face, since the liquid filter is formed into a bellows whose outer circumference is seamless.

This invention is conceived to solve the above-described problem inherent to the conventional liquid filter and the liquid filtration apparatus using the liquid filter, and to provide a novel liquid filter that is allowed for easy cleaning of any adhered foreign matter, and is reusable after cleaned up, and also to provide a liquid filtration apparatus using the liquid filter.

### Solution to Problem

This invention is proposed aiming at solving the problem. According to a first invention (the invention described in Claim 1), there is provided a liquid filter which includes: a liquid-receiving space into which a liquid flows, formed at the center; a plurality of ridge parts each extended in the direction orthogonal to the height direction, and vertically juxtaposed so as to be exposed individually to the front, back, left side and right side; and a plurality of valley parts each formed on the sides opposite to the individual positions of formation of the ridge parts, each extended in the direction orthogonal to the height direction, and vertically juxtaposed so as to form a part of the liquid-receiving space, the liquid filter being unfoldable from a folded state into a rectangular sheet body, and the sheet body in the folded state having its left end and right end overlapped at any position selected from the front, back, left side and right side.

According to the liquid filter of the first invention, the liquid flows into the liquid-receiving space formed inside thereof, and the foreign matter is trapped inside the liquid filter, in the process of flowing of the liquid out from the liquid filter, and the filtrate freed from the foreign matter is output. In other words, the liquid that flows into the liquid-receiving space is output through the liquid filter, after filtered. Since the liquid filter of this invention has the plurality of ridge parts formed on the outer side and the plurality of valley parts formed on the inner side, the liquid that comes in the liquid-receiving space can flow from the upper and lower sides of the individual valley parts towards the ridge parts, and can flow through the liquid filter into the outside. The liquid filter of this invention is unfoldable from a folded state having the ridge parts and the valley parts formed therein, into a flat rectangular sheet body. The liquid filter, after used for a predetermined duration of time, will have the foreign matter trapped and adhered on the inner face thereof. The thus unfolded sheet body may be re-folded so as to form the ridge parts and the valley parts to recover the folded state, and may be used again as the liquid filter.

In this invention, the sheet body in the folded state has its left end and right end overlapped at any position selected from the front, back, left side and right side, but not fixed. The width of overlap margin of the left side and the right side may properly be set depending on the size of liquid filter (or the area of sheet body), wherein the overlapping may be made while placing the left end of the sheet body on the outer side and the right end on the inner side, or may be made while placing the left end of the sheet body on the inner side and the right end on the outer side. Note that, in such folded state of the sheet body with its left end and right end overlapped, the individual ridge parts and the individual valley parts, which are formed on the right end of the sheet body and vertically juxtaposed, are positioned on the inner side and or the outside of the individual ridge parts and the individual valley parts which are formed on the left end of the sheet body and vertically juxtaposed.

The liquid filter of this invention, when depicted in terms of a manufacturing method, is formed by folding a rectangular sheet body, which is a filter material, so as to partially overlap the left end and the right end of the sheet body, wherein a plurality of ridge parts formed by mountain-folding of the sheet body appear (exposed) on the outer side, and a plurality of valley parts formed by valley-folding of the sheet body appear on the inner side, and a space surrounded by these valley parts appears as the liquid-receiving space.

Hence, the liquid filter of the first invention can output the liquid, coming into the liquid-receiving space, as a filtrate freed from foreign matters having been contained therein, and moreover, can easily be freed from foreign matters, having been trapped on the inner side of the liquid filter while it is used for a certain duration of time, typically by cleaning, since the liquid filter in its folded state has the left end and the right end of the sheet body overlapped, and may be unfolded from the folded state into a rectangular sheet body. The sheet body thus freed from foreign matters may be re-folded for the next use, making it reusable any number of times.

Since each of the ridge parts and the valley parts in the liquid filter of this invention extends in the direction orthogonal to the height direction, so that the filter case for housing the liquid filter can house a liquid filter having large numbers of ridge parts and valley parts per unit volume, allowing for a filtration area several times larger than that of the conventional liquid filter having the ridge parts and the valley parts formed in the height direction.

According to a second invention (the invention described in Claim 2), the sheet body in the first invention has, either on its left end or right end, slits individually formed at portions where the valley parts are formed, each of these slits having a length shorter than the width of overlap margin of the left end and the right end of the sheet body.

Since in the liquid filter of the second invention, the sheet body has, either on its left end or right end, slits individually formed at portions where the valley parts are formed, so that a part of the sheet body may be bent, making it easier to overlap the left end and the right end of the sheet body in the process of shaping. Since each of the slits has a length shorter than the width of overlap margin of the left, end and the right end of the sheet body, so that the unfiltered liquid may be prevented from leaking through the slits out from the liquid filter.

According to a third invention (the invention described in Claim 3), the liquid filter of the first or second invention has, formed either on the top edge or the bottom edge thereof, a connection tab that connects a particular liquid filter at the bottom edge or at the top edge thereof, with the other liquid filter disposed on the upper or lower side of the particular liquid filter, so as to prevent the liquid from leaking out through a portion between the particular liquid filter and the other liquid filter before being filtered.

In the third invention, there is formed the connection tab, and the connection tab prevents the liquid from leaking out through a portion between the particular liquid filter and the other liquid filter before being filtered. Hence, even for the case where the filter case for housing the liquid filter houses a plurality of liquid filters so as to be arranged vertically, the liquid may effectively be prevented from leaking out through a portion between the liquid filters. In particular, the liquid filter of the third invention can demonstrate a large effect explained below. It is intrinsically preferable that the filter case for housing the liquid filter houses only one liquid filter formed from a single sheet body. A single liquid filter is manufactured by cutting a web having a certain area to obtain a single sheet body having predetermined length and width, and by folding the sheet body. The web is, however, available only in limited length and width, so that also a single liquid filter manufacturable from the single sheet body will have the length limited by the length or width of web. When the filter case for housing the liquid filter has a capacity or volume far larger than the volume of a single liquid filter, housing of only a single liquid filter will not give a meaningful liquid filtration apparatus or a meaningful filter element. In short, according to the liquid filter of the third invention, a plurality of liquid filters connected through the connection tab may be housed in a predetermined filter case. Hence, the obtainable large effect is that a necessary number of liquid filters may be connected and housed, depending on the capacity of the filter case, even if every single liquid filter is available only in a limited length due to size of the obtainable web.

According to a fourth invention (the invention described in Claim 4), the connection tab of the third invention is disposed above the topmost ridge part that is formed at the topmost position of the plurality of ridge parts of the particular liquid filter, wherein the particular liquid filter and the other liquid filter are connected in such a way that the topmost ridge part is disposed outside the lowermost ridge part that is formed at the lowermost position of the plurality of ridge parts of the other liquid filter disposed on the upper side of the particular liquid filter; or, the connection tab is disposed below the lowermost ridge part that is formed at the lowermost position of the plurality of ridge parts of the particular liquid filter, wherein the particular liquid filter and the other liquid filter are connected in such a way that the lowermost ridge part is disposed outside the topmost ridge part that is formed at the topmost position of the plurality of ridge parts of the other liquid filter disposed on the lower side of the particular liquid filter. The liquid filter is unfordable from a folded state into a rectangular sheet body, inclusive of the connection tab.

The liquid filter of the fourth invention can prevent the unfiltered liquid from leaking through a portion between the particular liquid filter and the other liquid filter connected to the particular liquid filter, before being filtered, and moreover, will need only a predetermined rectangular sheet body when manufactured, so that it is neither necessary to employ a cutting process for cutting the sheet body as a filter material into an intricate shape (except for a slit contained in the liquid filter described in Claim 2), nor to craft metal dies with a cutting edge necessary for the cutting process. Hence, the liquid filter may be manufactured at very low costs, and will not be broken locally at the connection tab, even after repetitive unfolding, subsequent cleaning and re-folding.

According to a fifth invention (the invention described in Claim 5), there is provided a liquid filtration apparatus using the liquid filter described in any one of Claims 1 to 4, the apparatus includes a filter case that includes: a rectangular-shaped bottom plate, a rectangular-shaped lid plate, with the lower face opposed to the top face of the bottom plate, and with a circular liquid inlet opening formed at the center; a filter case having four side plates arranged between the bottom plate and the lid plate; and the liquid filter described in any one of Claims 1 to 4, housed in a space that is surrounded by the bottom plate, the lid plate and the four side plates. Each side plate has an outer opening through which a filtrate is output. The lid plate is detachably attached to the side plates, and has fixed at the center thereof the top end of the liquid inflow pipe body that communicates with the liquid inlet opening, and is inserted into the liquid-receiving space formed in the liquid filter. The liquid inflow pipe body has a plurality of inner openings through which a pre-filtered liquid is output.

According to the liquid filtration apparatus of the fifth invention, the unfiltered liquid, which comes through the liquid inlet opening formed at the center of the lid plate and through the top end of the liquid inflow pipe body into the liquid inflow pipe body, then flows through the inner openings formed in the liquid inflow pipe body into the liquid-receiving space formed in the liquid filter. The liquid thus coming into the liquid-receiving space is filtered through the liquid filter, and then output through the outer openings formed in the individual side plates. Since, as described previously, the liquid filter housed in the filter case has the individual valley parts juxtaposed in the height direction of the liquid filter, so that the individual valley parts before the liquid comes into the liquid-receiving space are kept in proximity due to their own weights, whereas they are brought apart when the liquid comes into the liquid-receiving space, as driven by inflow pressure of the liquid, allowing the liquid to flow outward (direction towards the ridge parts) through a portion between every adjacent valley parts.

Hence, also the liquid filtration apparatus of the fifth invention can output, like the individual liquid filters described above, the liquid after freed from foreign matters having been contained therein to the outside, with the filtration area several times larger than that of a liquid filtration apparatus (filter element) having housed therein the conventional liquid filter whose ridge parts and the valley parts are formed in the height direction.

According to the sixth invention (the invention described in Claim 6), the liquid inflow pipe body of the fifth invention has fixed on the outer circumference thereof a plurality of plate-like spacers arranged from the topmost part towards the bottommost part, the end portion of each spacer being inserted between a particular valley part formed in the liquid filter and the other valley part adjacent thereto, after inserted into the liquid-receiving space formed at the center of the liquid filter and then turned.

According to the liquid filtration apparatus of the sixth invention, since the spacers are fixed to the outer circumference of the liquid inflow pipe body, so that a particular valley part and the other valley part adjacent to the particular valley part, even if kept in proximity, may be forcedly brought apart by the spacers. Hence, the unfiltered liquid may be allowed to flow into a portion between the particular valley part and the other valley part, and thereby the filtering performance may be improved.

The number of the spacer formed on the outer circumference of the liquid inflow pipe body may be two or more, not always necessarily be same with the number of valley parts formed in the liquid filter. For example, when a liquid filter having formed therein 16 valley parts in total is housed, three of four spacers will suffice, allowing the neighboring spacers to embrace five or four valley parts in between. The plane geometry of each spacer will be good enough if it has, on its end, a portion insertable between a particular valley part and the other valley part adjacent thereto formed in the liquid filter, after inserted into the liquid-receiving space and then turned. For example, when the liquid-receiving space appears as a square in plan view, the plane geometry of the spacer may be a square with the sides slightly shorter than the sides of the liquid-receiving space in plan view. The spacers thus given in the square form as described above are forcedly inserted between the adjacent valley parts formed in the liquid filter, after turned within the range from 5° to 60° (preferably 45°). The number of the portions (within a single plane) forcedly inserted between the adjacent valley parts formed in the liquid filter may be one, or two or more. Each spacer may have, on the left and right sides of the portion to be inserted between the adjacent valley parts, thinned parts with a reduced thickness. Provision of such thinned parts on the left and right sides of the portion to be inserted between the adjacent valley parts will make the insertion between the adjacent valley parts smoother, and a thick part formed between both thinned parts will form a wider space between the adjacent valley parts.

According to a seventh invention (invention described in Claim 7), the spacer in the sixth invention, which is fixed at the topmost position out of the plurality of spacers fixed to the liquid inflow pipe body, has four portions whose top faces are used to hold, jointly with the lower face of the lid plate, the topmost part of the liquid filter on the inner circumferential side, after inserted into the liquid-receiving space and then turned.

The liquid filtration apparatus of the seventh invention has the spacers each having four portions whose top faces are used to hold, jointly with the lower face of the lid plate, the topmost part of the liquid filter on the inner circumferential side, after inserted into the liquid-receiving space formed at the center of the liquid filter together with the liquid inflow pipe body, and then turned. The spacer is the one fixed to the top end of the liquid inflow pipe body (a position closest to the lid plate), and has four portions whose top faces are used to hold, jointly with the lower face of the lid plate, the topmost part of the liquid filter on the inner circumferential side. In other words, each spacer has portions that hold, jointly with the lower face of the lid plate, the topmost part of the liquid filter on the inner circumferential side at four positions, after inserted into the liquid-receiving space and then turned. Hence, the liquid filtration apparatus of the seventh invention can effectively prevent the unfiltered liquid, which is coming into the liquid-receiving space formed at the center of the liquid filter, from entering between the top face of the liquid filter and the lower face of the lid plate, as driven by the load and pressure of the liquid, and from leaking to the outside before being filtered.

As described above, the spacer that composes the seventh invention has four portions used to hold, jointly with the lower face of the lid plate, the topmost part of the liquid filter, wherein there may be a plurality of valley parts, and not always necessarily a single valley part, positioned between the spacer and the lid plate.

According to an eighth invention (the invention described in Claim 8), the spacer in either the sixth or seventh invention, which is fixed at the lowermost position, out of the plurality of spacers fixed to the liquid inflow pipe body, has four portions whose lower faces are used to hold, jointly with the top face of the bottom plate, the bottommost part of the liquid filter on the inner circumferential side, after inserted into the liquid-receiving space and then turned.

The liquid filtration apparatus of the eighth invention has the spacers each having four portions whose lower faces are used to hold, jointly with the top face of the bottom plate, the bottommost part of the liquid filter on the inner circumferential side, after inserted into the liquid-receiving space formed at the center of the liquid filter together with the liquid inflow pipe body, and then turned. The spacer is the one fixed to the bottom end of the liquid inflow pipe body (a position closest to the bottom plate), and has four portions whose bottom faces are used to hold, jointly with the top face of the bottom plate, the bottommost part of the liquid filter on the inner circumferential side. In other words, each spacer has portions that hold, jointly with the top face of the bottom plate, the bottommost part of the liquid filter on the inner circumferential side at four positions, after inserted into the liquid-receiving space and then turned.

Hence, the liquid filtration apparatus of the eighth invention can effectively prevent the unfiltered liquid, which is coming into the liquid-receiving space formed at the center of the liquid filter, from entering between the lower face of the liquid filter and the top face of the bottom plate, as driven by the load and pressure of the liquid, and from leaking to the outside before being filtered. In particular, the liquid filtration apparatus, individually having fixed thereto the spacer that composes the eight invention and the spacer that composes the seventh invention can effectively prevent a risk of leakage of the unfiltered liquid through both of the topmost and bottommost parts of the liquid filter to the outside. Moreover, the liquid filtration apparatus also employs a means for avoiding such risk of leakage of unfiltered liquid to the outside, in which the topmost and bottommost parts of the liquid filter are individually held jointly with the spacer and the lid plate that compose the seventh invention, and, by the spacer and the bottom plate that compose the eighth invention. Since the liquid filter is neither designed to fix the top face thereof to the lower face of the lid plate, nor to fix the bottom face thereof to the upper face of the bottom plate, so that only the liquid filter, with foreign matters adhered on the inner circumferential face thereof over a predetermined duration of use, may be detached from the filter case, may independently be cleaned to remove the foreign matters, and may be rehoused in the filter case. In short, according the liquid filtration apparatus of the eighth invention, reciting the seventh invention, it now becomes possible to achieve both of cleanability and reusability, which are the most striking features of the liquid filters of the aforementioned first to fourth inventions, without degrading the filtration performance that is basically and normally required of the liquid filter.

### Advantageous Effects of Invention

According to the first invention (the invention described in Claim 1), the liquid filter can output the liquid, coming into the liquid-receiving space, as a filtrate freed from foreign matters having been contained therein, and moreover, can easily be freed from foreign matters, trapped on the inner side of the liquid filter as it is used for a certain duration of time, typically by cleaning, since the liquid filter in its folded state has the left end and the right end of the sheet body overlapped, and may be unfolded from the folded state into a rectangular sheet body. The sheet body thus freed from foreign matters may be re-folded for the next use, making it reusable any number of times. Since each of the ridge parts and the valley parts in the liquid filter of this invention extends in the direction orthogonal to the height direction, so that the filter case for housing the liquid filter can house a liquid filter having large numbers of ridge parts and valley parts per unit volume, allowing for a filtration area several times larger than that of the conventional liquid filter having the ridge parts and the valley parts formed in the height direction.

According to the second invention (the invention described in Claim 2), the liquid filter may be formed very easily, by folding a rectangular-shaped sheet body and then overlapping the left end and the right end thereof.

According to the liquid filter of the third invention (the invention described in Claim 3), a plurality of liquid filters may be connected through a connection tab, preventing the liquid from leaching from a portion between a particular liquid filter and the other liquid filter to the outside, before being filtered.

According to the fourth invention (the invention described in Claim 4), the liquid filter can prevent the unfiltered liquid from leaking through a portion between the particular liquid filter and the other liquid filter connected to the particular liquid filter before being filtered, and moreover, will need only a predetermined rectangular sheet body when manufactured, so that it is neither necessary to employ a cutting process for cutting the sheet body as a filter material into an intricate shape (except for a slit contained in the liquid filter described in Claim 2), nor to craft metal dies with a cutting edge necessary for the cutting process. Hence, the liquid filter may be manufactured at very low costs, and will not he broken locally at the connection tab, even after repetitive unfolding, subsequent cleaning and re-folding.

Also the liquid filtration apparatus of the fifth invention (the invention described in Claim 5) can output, like the individual liquid filters described above, the liquid after freed from foreign matters having been contained therein to the outside, with the filtration area several times larger than that of a liquid filtration apparatus (filter element) having housed therein the conventional liquid filter whose ridge parts and the valley parts are formed in the height direction.

According to the liquid filtration apparatus of the sixth invention (the invention described in Claim 6), even if a particular valley part and the other valley part adjacent to the particular valley part formed in the liquid filter are kept in proximity, they may be forcedly brought apart by the spacers. Hence, the unfiltered liquid may be allowed to flow into a portion between the particular valley part and the other valley part, and thereby the filtering performance may be improved.

According to the seventh invention (the invention described in Claim 7), the liquid filtration apparatus can effectively prevent the unfiltered liquid, which is coming into the liquid-receiving space formed at the center of the liquid filter, from entering between the top face of the liquid filter and the lower face of the lid plate, as driven by the load and pressure of the liquid, and from leaking to the outside before being filtered.

According to the eighth invention (the invention described in Claim 8), the liquid filtration apparatus can effectively prevent the unfiltered liquid, which is coming into the liquid-receiving space formed at the center of the liquid filter, from entering between the lower face of the liquid filter and the top face of the bottom plate, as driven by the load and pressure of the liquid, and from leaking to the outside before being filtered. In particular, according the liquid filtration apparatus of the eighth invention, reciting the seventh invention, it now becomes possible to achieve both of cleanability and reusability, which are the most striking features of the liquid filters of the aforementioned first to fourth inventions, without degrading the filtration performance that is basically and normally required of the liquid filter.

### BRIEF DESCRIPTION OF DRAWINGS

FIG. 1 is a side cross-sectional view illustrating a liquid filtration apparatus.

FIG. 2 is a plan view of a liquid filter.

FIG. 3 is a left side elevation illustrating the liquid filter stretched vertically.

FIG. 4 is a front elevation illustrating the liquid filter stretched vertically.

FIG. 5 is a development view of a sheet body.

FIG. 6 is an enlarged plan view of the sheet body illustrating a slit formed therein.

FIG. 7 is a side cross-sectional view illustrating the sheet body overlapped at the front side of the liquid filter.

FIG. 8 is a left side elevation illustrating an upper filter and a lower filter connected through a connection tab.

FIG. 9 is a cross-sectional view illustrating the upper filter and the lower filter connected through the connection tab.

FIG. 10 is an exploded perspective view illustrating a case body and a lid plate.

FIG. 11 is a front elevation illustrating the case body and the lid plate illustrated in FIG. 10.

FIG. 12 is a right side elevation illustrating the case body.

FIG. 13 is a front elevation illustrating an upper front panel portion and a lower front panel portion mutually connected.

FIG. 14 is a right side elevation illustrating an upper front panel portion and a lower front panel portion mutually connected.

FIG. 15 is a left side cross-sectional elevation illustrating the filter case.

FIG. 16 is a plan view illustrating a bottom panel member.

FIG. 17 is an enlarged front elevation illustrating a connection structure between the upper front panel and the lower front panel.

FIG. 18 is an enlarged perspective view illustrating a connection structure between an upper front panel and a lower front panel.

FIG. 19 is a front elevation of the filter case in the process of folding the right side panel and the left side panel.

FIG. 20 is a left side elevation of the filter case in the process of folding the upper front panel and the lower front panel, and an upper back panel and a lower back panel, individually.

FIG. 21 is a front elevation illustrating a collapsed filter case.

FIG. 22 is a left side elevation illustrating a collapsed filter case.

FIG. 23 is an enlarged exploded cross-sectional view illustrating the liquid inflow pipe and the bottom panel portion.

FIG. 24 is an enlarged cross-sectional view illustrating a liquid inflow pipe connected to a pipe joint portion fixed to the bottom panel portion.

FIG. 25 is a schematic plan view illustrating a positional relation among the liquid filter, the lid plate and spacers.

FIG. 26 is a schematic plan view illustrating the lid plate turned 45° from the position illustrated in FIG. 25.

FIG. 27 is an enlarged side cross-sectional view illustrating a part of filter held in between by the lid plate and the spacer arranged at the topmost position.

FIG. 28 is an enlarged side cross-sectional view illustrating a part of the filter held in between by the bottom panel portion and the spacer arranged at the lowermost position.

FIG. 29 is an enlarged side cross-sectional view illustrating a positional relation between the filter and the spacers.

FIG. 30 is an enlarged side cross-sectional view illustrating the liquid coming into the filter case from the state illustrated in FIG. 29.

FIG. 31 is an enlarged cross-sectional view illustrating an essential part of a connection structure between the lid plate and the liquid inflow pipe.

FIG. 32 is a schematic front cross-sectional view illustrating a liquid filtration apparatus of a second embodiment.

### DESCRIPTION OF EMBODIMENTS

The liquid filtration apparatus according to the best modes for carrying out this invention will be detailed below, referring to the attached drawings.

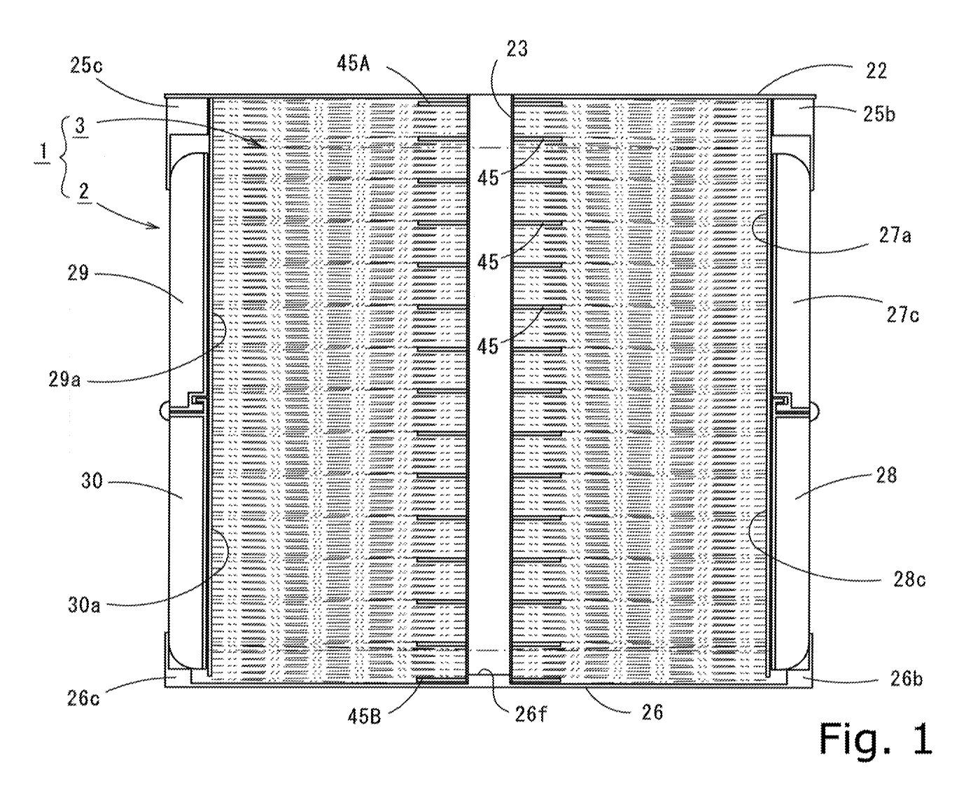

A liquid filtration apparatus 1 of this embodiment is composed of, as illustrated in FIG. 1, a filter case 2, and a plurality of liquid filters (simply referred to as “filters”, hereinafter) 3 housed in the filter case 2. Detailed description will be made firstly on the filter 3, and then on the filter case 2.

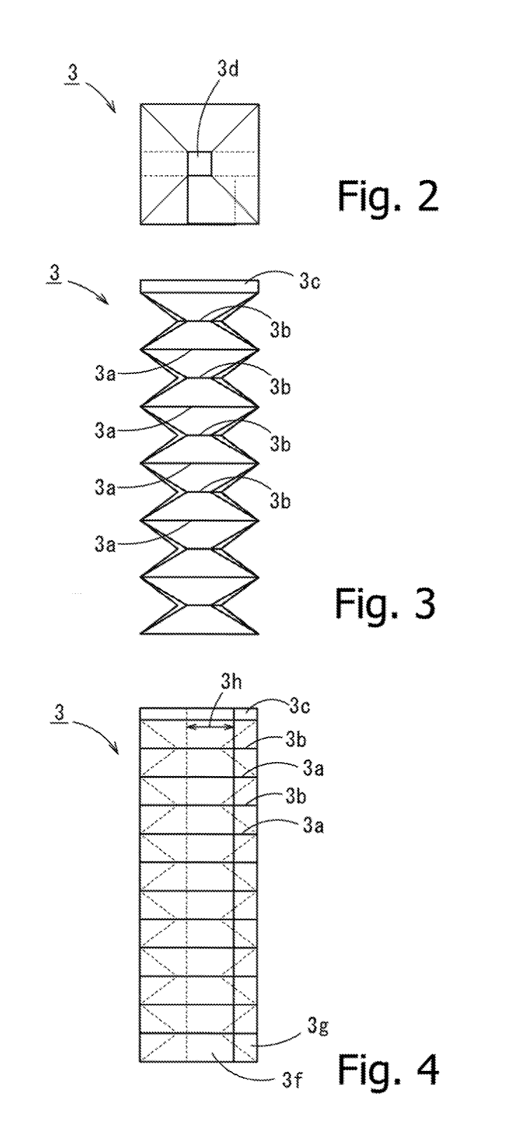

The individual filters 3 are formed into the same shape, connected in the height direction while placing in between a connection tab 3c described later, made of nonwoven fabric typically composed of acrylic fiber or other synthetic fiber, and is water-permeable but can trap foreign matters contained in liquid. Each filter 3 is formed into a square as seen in a plan view given by FIG. 2, seen to have ridge parts 3a and valley parts 3b formed alternately in a left side view given by FIG. 3, and again seen to have the ridge parts 3a and the valley part 3b formed alternately in a front view given by FIG. 4. The ridge parts 3a and the valley parts 3b extend in the direction orthogonal to the height direction of the filter 3. Each filter 3 also has a connection tab 3c formed at the top edge thereof, The filter 3, formed into a square in a plan view as illustrated in FIG. 2, has a square liquid-receiving space 3d formed at the center thereof. The liquid-receiving space 3d is a portion where an unfiltered liquid is input.

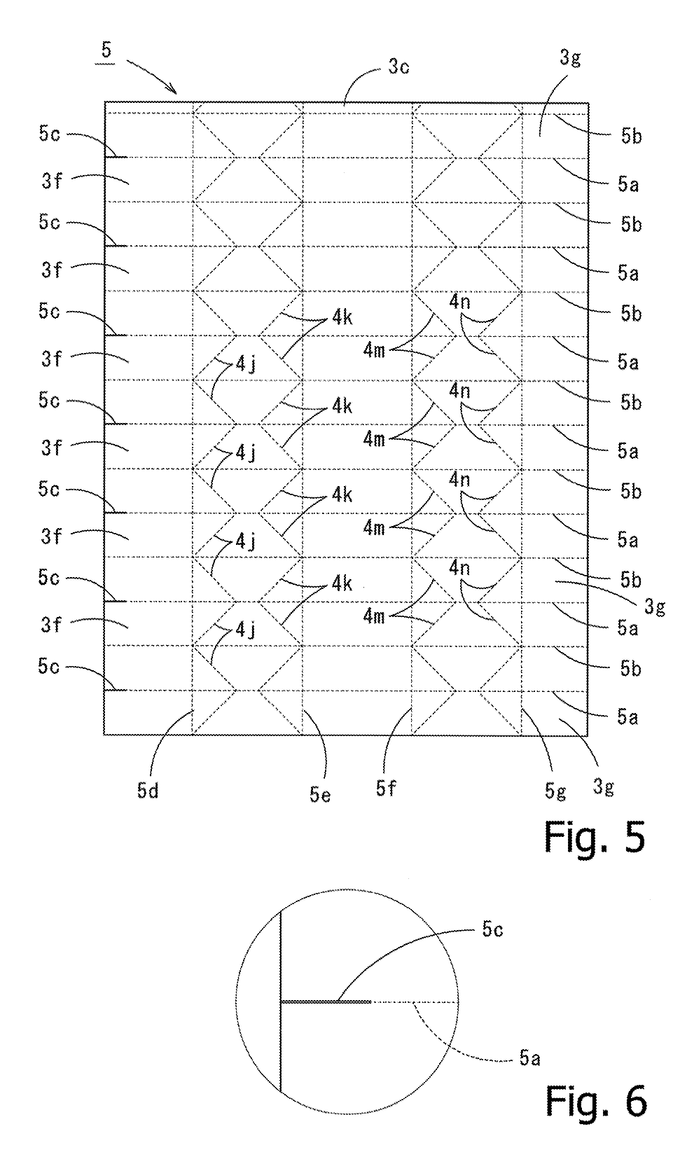

The filter 3 is formed by folding a rectangular-shaped sheet body 5 as illustrated in FIG. 5. A method of folding the sheet body 5 will be briefed. Note that, in FIG. 5, all portions indicated by broken lines are portions to be folded (the portions to be folded will be referred to as “folding line”, hereinafter). Of these folding lines, a first horizontal folding line 5a that extends transversely lies at the lowermost position, a second horizontal folding line 5b is positioned above the first horizontal folding line 5a in parallel thereto, and again the first horizontal folding line 5a is positioned above the second horizontal folding line 5b. In this way, the first horizontal folding lines 5a and the second horizontal folding lines 5b are alternately positioned at regular intervals from the bottom to the top of the sheet body 5. Each first horizontal folding line 5a corresponds to a portion where the sheet body 5 is valley-folded (excluding a portion where partially mountain-folded later), and each second horizontal folding line 5b corresponds to a potion where the sheet body 5 is mountain-folded. In other words, in the process of manufacturing or shaping the filter 3 by folding the rectangular-shaped sheet body 5, mountain folding and valley folding are alternately repeated at the portions where the first horizontal folding lines 5a and the second horizontal, folding lines 5b alternately lie, to thereby make a pleated work, not illustrated, having a width corresponded to the distance from the first horizontal folding line 5a to the second horizontal folding line 5b. The portion which serves as the connection tab 3c adjoins to the sheet body 5, bounded by the second horizontal folding line 5b that is formed at the topmost part of the sheet body 5 and is mountain-folded, and has a width narrower than the distance between the second horizontal folding line 5a and the first horizontal folding line 5b. At the individual positions of the sheet body 5 which correspond to the folding lines 5a to be valley-folded, there are formed slits 5c in the direction from the left end towards the right ends as illustrated in FIG. 5 and FIG. 6. The length of each slit 5c is shorter than the width of overlap margin 3h described later.

After the pleat-formed folded work was completed, the sheet body 5 is once unfolded, and then folded, unidirectionally at positions of four (first to fourth) vertical folding lines 5d . . . 5g that are formed in parallel to each other and in the longitudinal direction of the sheet body 5. That is, after folding the sheet body 5 at the positions of the first to fourth vertical folding lines 5d . . . 5g so as to overlap the left and right ends of the sheet body 5 on this side of FIG. 5, the face of the sheet body 5 seen in FIG. 5 will form the inner faces of the finished filter 3, meanwhile, after folding the sheet body 5 entirely in the opposite direction, the face of the sheet body 5 opposite to the face seen in FIG. 5 will form the enter faces of the finished filter 3. In this example, the description will be made on the former method of folding the first to fourth vertical folding lines 5d . . . 5g. The width of an area that ranges from the first vertical folding line 5d, which is the leftmost one out of the first to fourth vertical folding lines 5d . . . 5g, to the second vertical folding line 5e that lies on the right of the vertical first folding line 5d (this area will form the left side face of the filter 3 in this example); the width of an area that ranges from the second vertical folding line Se to the third vertical folding line 5f that lies on the right of the second vertical folding line 5e (the area will form the rear face of the filter 3); and the width of an area that ranges from the third vertical folding line 5f to the fourth vertical folding line 5g that lies on the right of the third vertical folding line 5f (the area will form the right side face of the filter 3) are all the same. Note that, one front-forming part 3f that ranges from the left end of the sheet body 5 to the first vertical folding line 5d (see FIG. 5), and other front-forming part 3g that ranges from the right end of the sheet body 5 to the fourth vertical folding line 5g (see FIG. 5) in this example are portions both positioned on the front of the filter 3. The total width of the one front-forming part 3f and the other front-forming part 3g is longer than the front width of the filter 3, and a difference between such total and the front width of the filter 3 equals to width of the overlap margin 3h that appears when the one front-forming part 3f and the other front-forming part 3g are overlapped on the front of the filter 3 (see FIG. 4). In this example, the one front-forming part 3f and the other front-forming part 3g are overlapped so as to dispose the end of the other front-forming part 3g behind the one front-forming part 3f. The width of the overlap) margin 3h defined by overlapping of the one front-forming part 3f and the other front-forming part 3g is set shorter than the length of the slits 5c.

Upon completion of mountain-folding individually on the first to fourth vertical folding lines 5d . . . 5g, the first to fourth vertical folding line 5d . . . 5g are kept mountain-folded at approximately 90°, each portion between the first vertical folding line 5d and the second vertical folding line 5e, having been valley-folded along every first horizontal folding line 5a, is folded back into a mountain over a predetermined range at around the center, and each first straight diagonal folding line 4j (see FIG. 5), which is defined between the left end of the first horizontal folding line 5a thus folded back into a mountain and each intersection where the mountain-folded second horizontal folding line 5b and the first vertical folding line 5d intersect, is then valley folded. These first diagonal folding lines 4j as a whole appear as a meandering folding line regularly kinked at 90°. Each second straight diagonal folding line 4k (see FIG. 5), which is defined between the right end of the first horizontal folding line 5a thus folded back into a mountain, and each intersection where the mountain-folded second horizontal folding line 5b and the second vertical folding line 5e intersect, is then valley folded. These second diagonal folding lines 4j as a whole appear as a meandering folding line regularly kinked at 90°. Each portion between the third vertical folding line 5f and the fourth vertical folding line 5g, having been valley-folded along every first horizontal folding line 5a, is folded back into a mountain over a predetermined range at around the center, and each third straight diagonal folding line 4m (see FIG. 5), which is defined between the left end of the first horizontal folding line 5a thus folded back into a mountain and each intersection where the mountain-folded second horizontal, folding line 5b and the third vertical folding line 5f intersect, is then valley folded. These third diagonal folding lines 4m as a whole appear as a meandering folding line regularly kinked at 90°. Each fourth straight diagonal folding line 4n (see FIG. 5), which is defined between the right end of the first horizontal folding line 5a thus folded back into a mountain, and each intersection where the mountain-folded second horizontal folding line 5b and the fourth vertical folding line 5g intersect, is then valley folded. These fourth diagonal folding lines 4n as a whole appear as a meandering folding line regularly kinked at 90°.

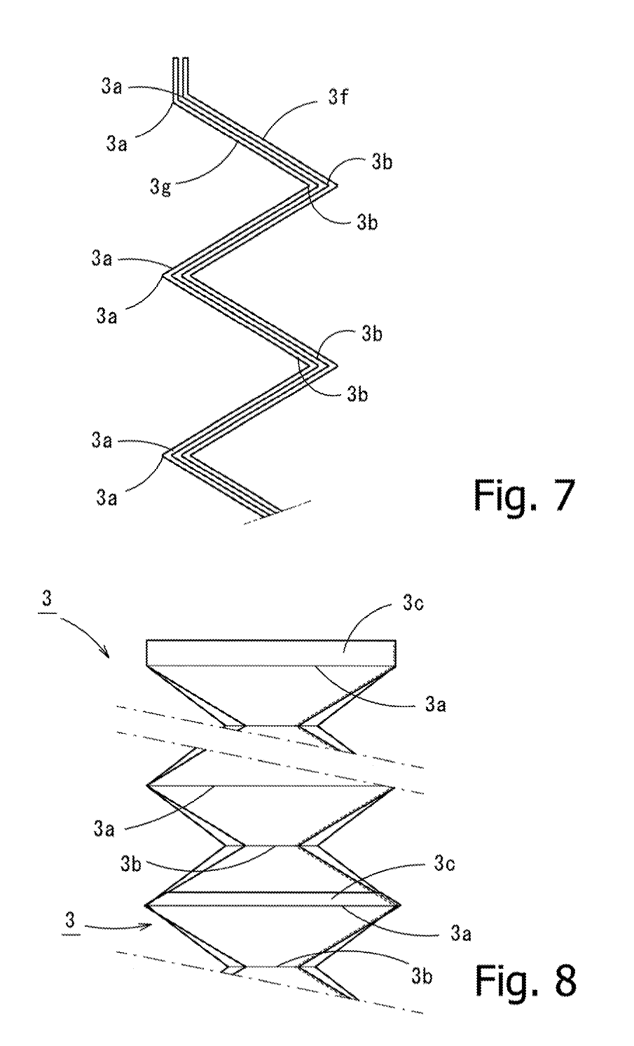

Upon completion of folding along the individual folding lines (symbols not assigned) as described above, the sheet body 5 will have a near tubular, three-dimensional shape. In particular, since the sheet body 5 is folded at 90° individually along the first to fourth vertical folding lines 5d . . . 5g, the left end and the right end of the sheet body 5 irregularly overlap. Then the one front-forming part 3f and the other front-forming part 3g are overlapped with each other, so that the one front-forming part 3f comes front, and the other front-forming part 3g comes behind such one front-forming part 3f, as described previously. In this process, since there are slits 5c that are formed along the first horizontal folding lines 5a and extends rightward from the left end of the sheet body 5, the worker can turn a part of the sheet body 5 at each slit 5c and deflect it outward (frontward), and can arrange a part of the other front-forming part 3g behind the one front-forming part 3f, making use of a space left behind the deflected part (see FIG. 7). In other words, in the process of shaping and manufacturing the filter 3 by folding the sheet body 5, an arrangement work for placing the part of the other front-forming part 3g behind the one front-forming part 3f will become smoother, by virtue of the slits 5c provided to the sheet body 5.

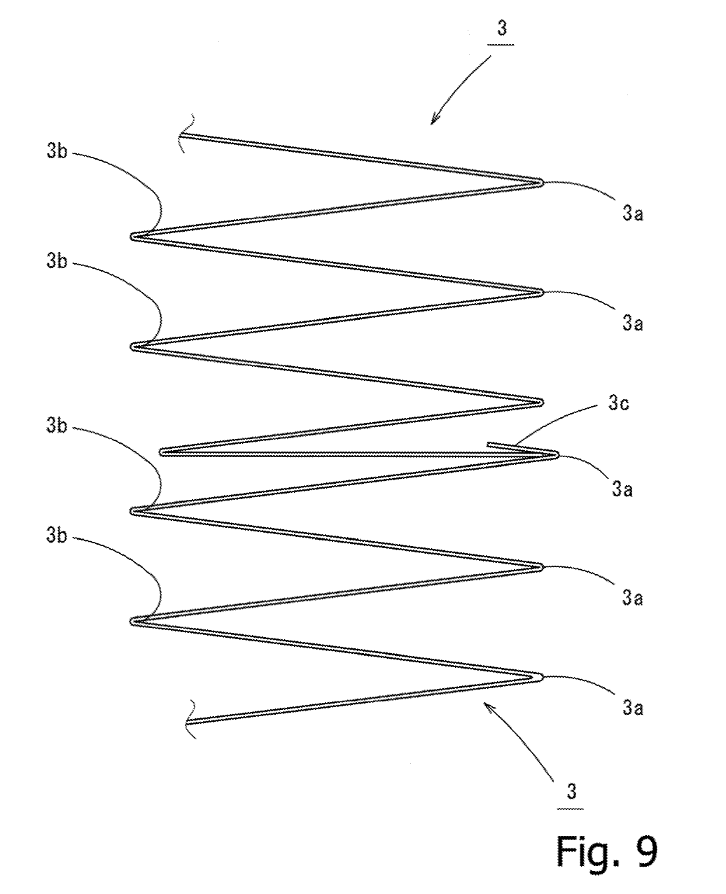

In such a way, the sheet body 5 is finally given a form of the filter 3 illustrated in FIG. 3 or FIG. 4. In the liquid filtration apparatus 1 of this embodiment, there are housed a plurality of filters 3 vertically connected to each other. FIG. 8 and FIG. 9 individually illustrate a state of connection of the filter 3 positioned on the lower side (a particular filter composing this invention), with the upper filter (the other filter composing this invention) whose bottom end is connected to the top end of the above-described filter 3 positioned on the lower side, wherein the end of the connection tab 3c formed in the upper portion of the filter 3 positioned on the lower side is positioned on the side of the valley part 3b formed lowermost in the upper filter 3. The base end of the connection tab 3c formed in the lower filter 3 coincides with the ridge part 3a (the topmost ridge part composing this invention) formed topmost in the lower filter 3, and also corresponds to the second horizontal folding line 5b positioned topmost of the sheet body 5 illustrated in FIG. 5. The bottommost edge of the upper filter 3 is positioned, as illustrated in FIG. 9, right under the ridge part 3a positioned bottommost of the upper filter 3, and the bottom edge thereof is the bottom edge of the sheet body 5. The bottom edge of the upper filter 3 is positioned behind the ridge part 3a formed topmost in the lower filter 3. Accordingly, the connection tab 3c surrounds the whole outer circumference of the upper filter 3 from the outside.

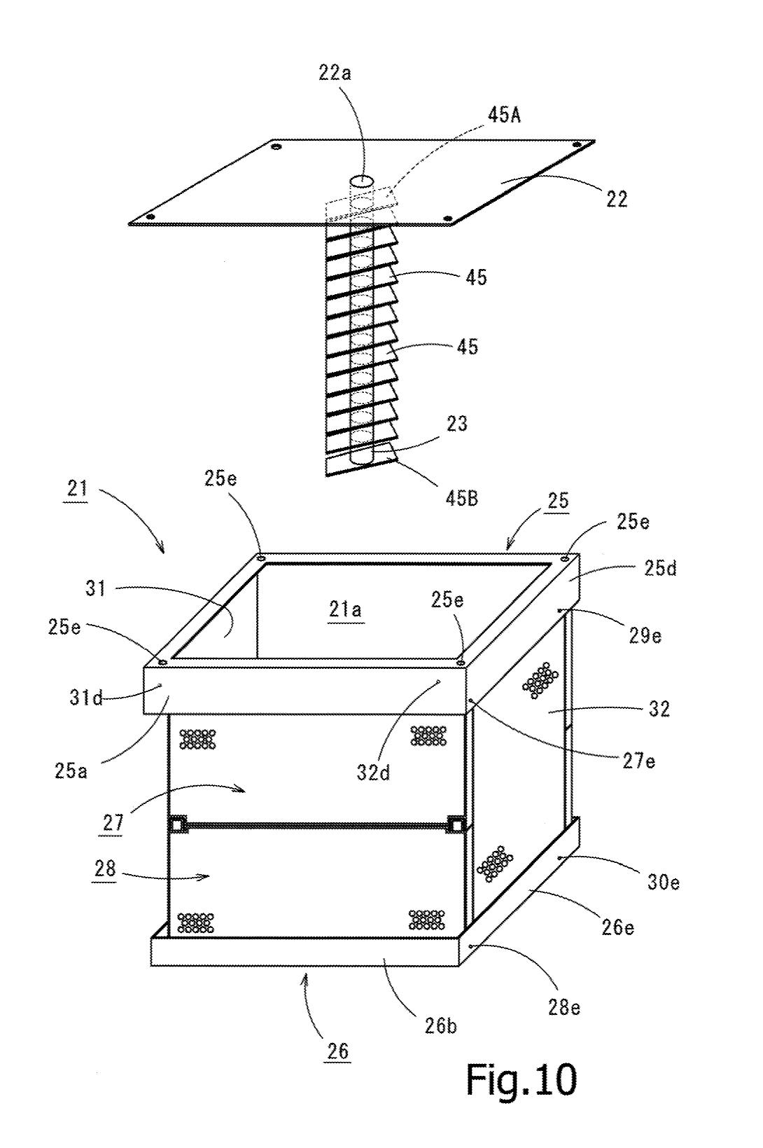

Next, the filter case 2 will foe detailed. The filter case 2 has, as illustrated in FIG. 10, a case body 21 having a square opening 21a at the top, a lid plate 22 that closes the opening 21a of the case body 21 from the top, and a liquid inflow pipe 23 whose top edge is fixed to the lower face of the lid plate 22.

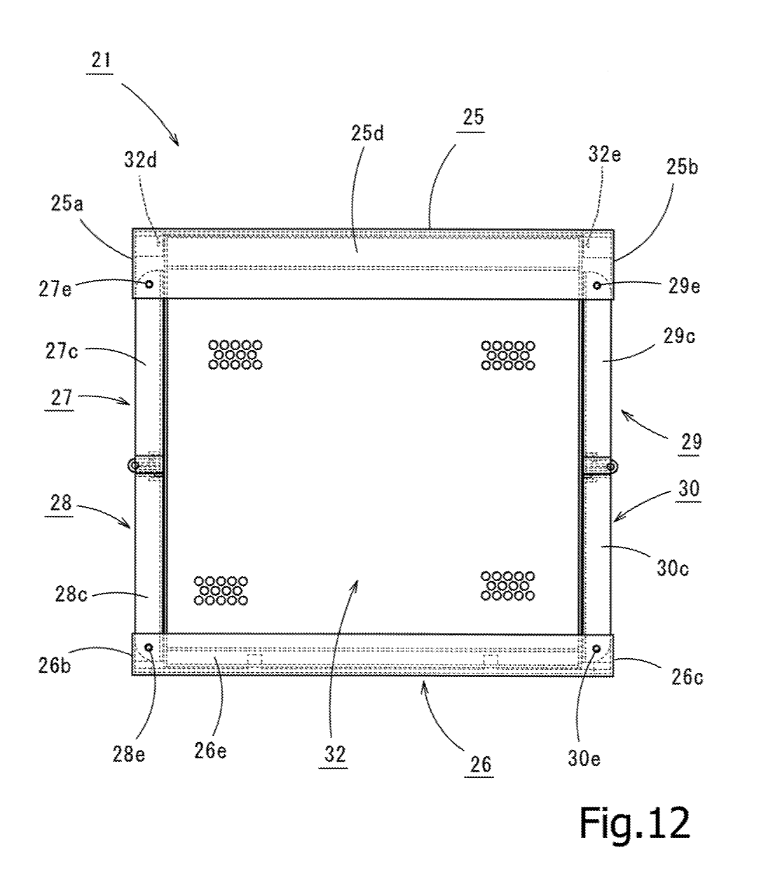

The case body 21 is composed of the components below which are integrally formed using a resin. That is, as illustrated in FIG. 10, the case body 21 has a frame member 25 that is positioned topmost and has the square opening 21a formed inside thereof; a bottom panel member 26 arranged in the lower portion of the case body 21; an upper front panel 27 and a lower front panel 28 arranged on the front of the case body; an upper back panel 29 (see FIG. 12) and a lower back panel 30 (see FIG. 12) arranged on the back of the case body 21; a left side panel 31 positioned on the left side of the case body 21; and a right side panel 32 positioned on the right side of the case body 21. The upper front panel 27, the lower front panel 28, the upper back panel 29, the lower back panel 30, the left side panel 31 and the right side panel 32 have formed therein through-holes (symbols not given) through which the filtrate is output. Both of the upper front panel 27 and the lower front panel 28 compose a front panel. In this example, the front panel is halved into the upper front panel 27 and the lower front panel 28. Both of the upper back panel 29 and the lower back panel 30 compose a back panel. In this example, the back panel is halved into the upper back panel 29 and the lower back panel 30.

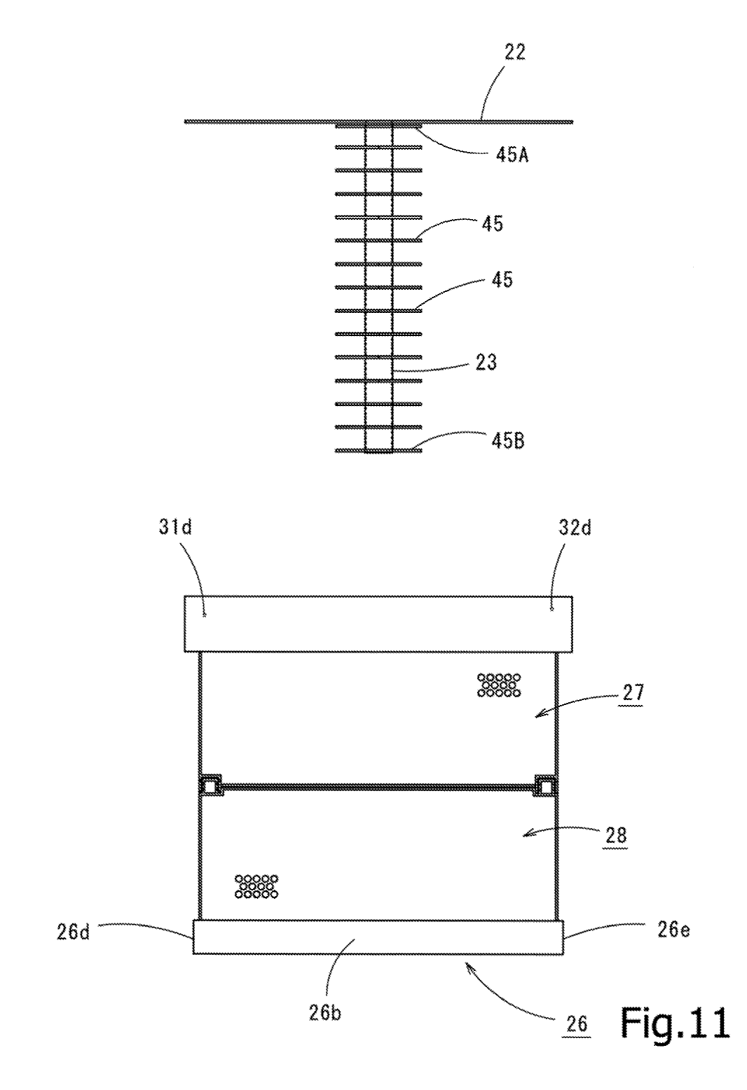

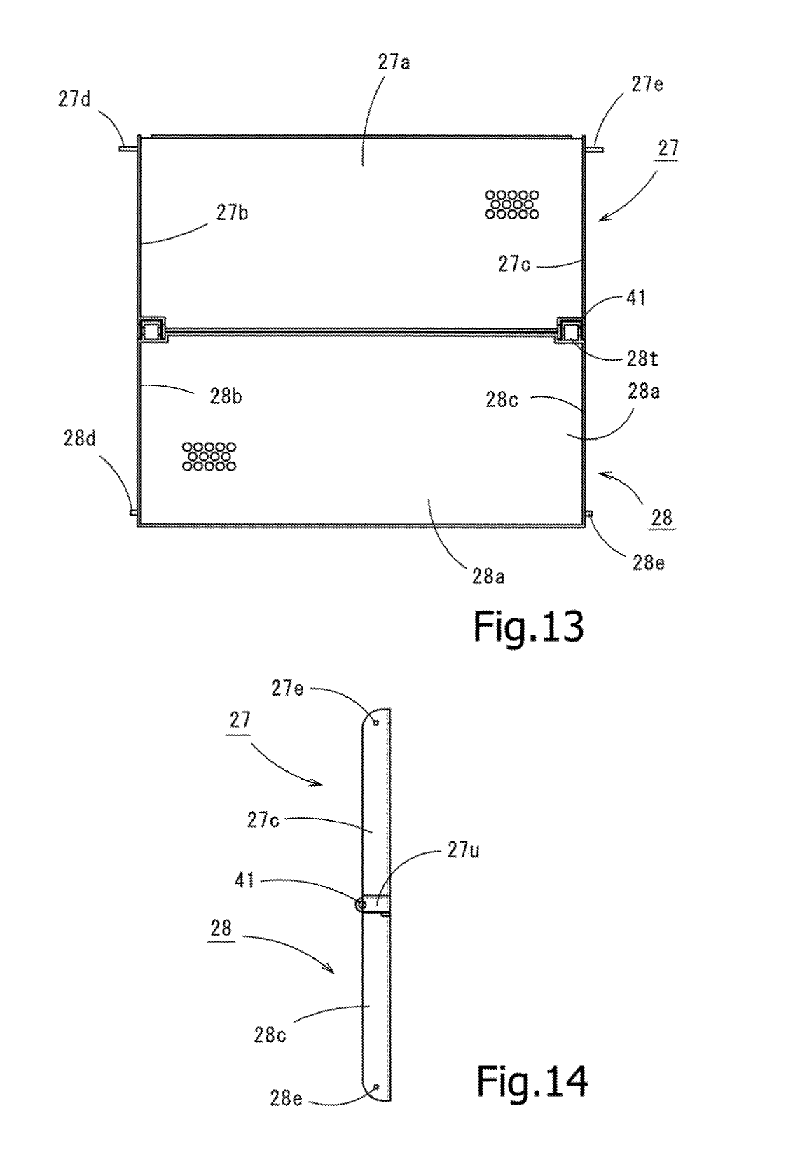

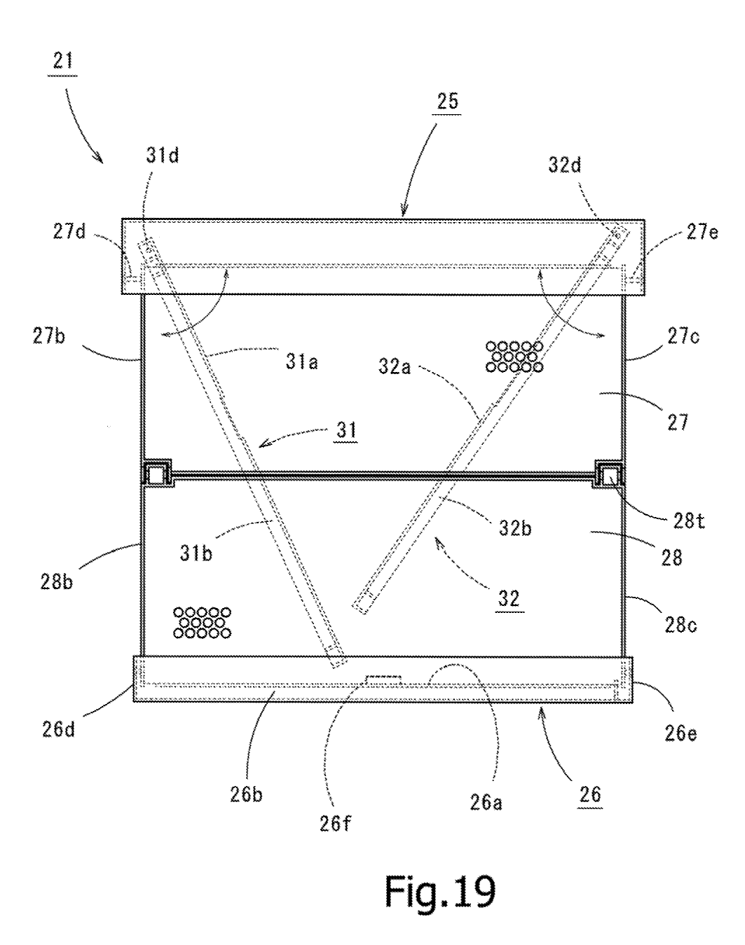

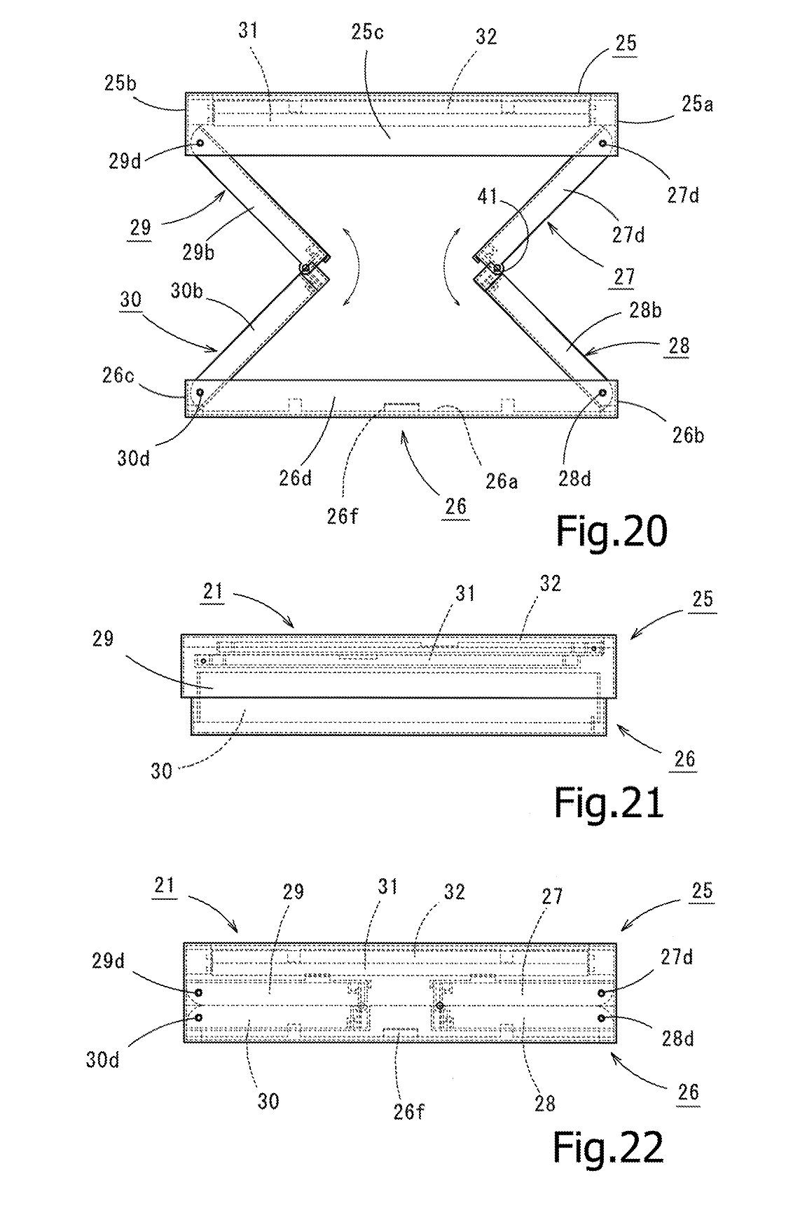

The frame member 25 has, as illustrated in FIG. 10, FIG. 11, or FIG. 12, a front panel portion 25a, a back panel portion 25b, a left side panel portion 25c and a right side panel portion 25d, and has threaded holes 25e for fixing the lid plate 22, formed at the corners of the top face thereof. At a portion on the front side of the left side panel portion 25c formed in the frame member 25 and at the middle of the lower end side, there is formed a first shaft insertion hole (symbol not assigned) into which a first pivoting shaft 27d (see FIG. 13 or FIG. 19), formed on the left side face on the top end side of an upper left upright panel portion 27b composing the upper front panel 27 described later, is inserted. At a portion on the lower end side of the front side of the right side panel portion 25d, there is formed a second shaft insertion hole (symbol not assigned) into which a second pivoting shaft 27e (see FIG. 12), formed at a middle on the top end side of the upper right upright panel portion 27c composing the upper front panel 27 described later, is inserted. At a portion on the back side of the left side panel portion 25c formed in the frame member 25 and at the middle of the lower end side, there is formed a third shaft insertion hole (symbol not assigned) into which a third pivoting shaft 29d (see FIG. 20), formed on the left side face on the top end side of the left upright panel portion 29b composing the upper back panel 29 described later, is inserted. At a portion on the back side of the right side panel portion 25d formed in the frame member 25 and at the middle of the lower end side, there is formed a fourth shaft insertion hole (symbol not assigned) into which a fourth pivoting shaft 29e (see FIG. 10), formed on the right side face on the top end side of the right upright panel portion 29c composing the upper back panel 29 described later, is inserted. At a left middle portion of the front side plate 25a formed in the frame member 25, there is formed a fifth shaft insertion hole (symbol not assigned) into which a fifth pivoting shaft 31d (see FIG. 10 or FIG. 19), formed at a middle on the top end side of the front panel portion 31b formed in the left side panel 31 described later, is inserted. At a left middle portion of the back side plate 25b formed in the frame member 25, there is formed a sixth shaft insertion hole (symbol not assigned) into which an unillustrated sixth pivoting shaft formed at a middle on the top end side of the back panel portion formed in the unillustrated left side panel 31, is inserted. At a right middle portion of the front side plate 25a formed in the frame member 25, there is formed a seventh shaft insertion hole (symbol not assigned) into which a seventh pivoting shaft 32d (see FIG. 10 or FIG. 19), formed at a middle on the top end side of the front panel portion 31b formed in the right side panel 32 described later, is inserted. At a right middle portion of the back side plate 25b formed in the frame member 25, there is formed an eighth shaft insertion hole (symbol not assigned) into which an eighth pivoting shaft 32e, formed at a middle on the top end side of the back panel portion 32c formed in the right side panel 32 described later, is inserted. Note that positions, where the seventh shaft insertion hole allowed for insertion of the seventh pivoting shaft 32d, and the eighth shaft insertion hole allowed for insertion of the eighth pivoting shaft 32e are formed, are set higher than the positions where the fifth shaft insertion hole and the sixth shaft insertion hole are formed, and as described later, each of the upper front panel 27 and the upper back panel 29 are set higher than the level of height of horizontal collapse.

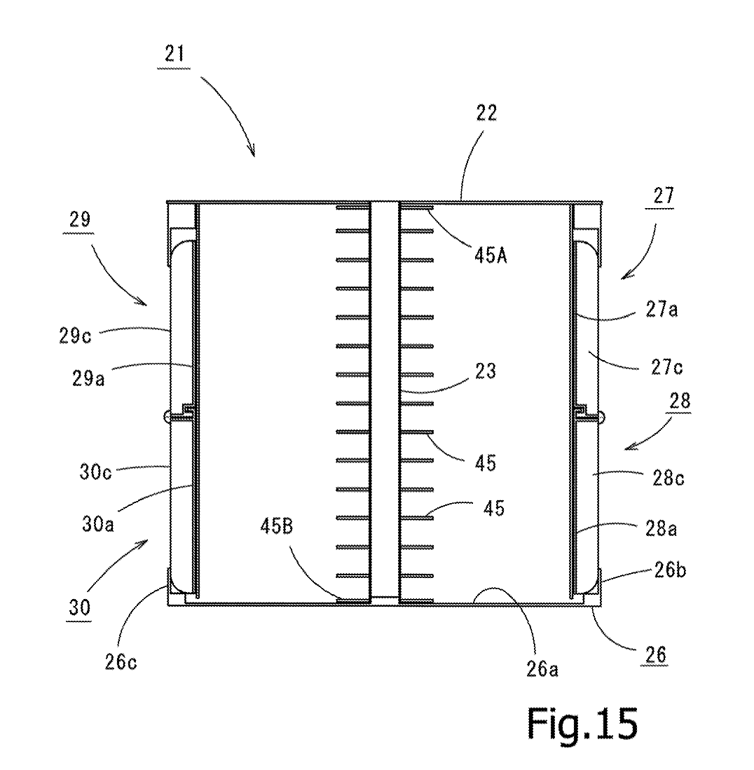

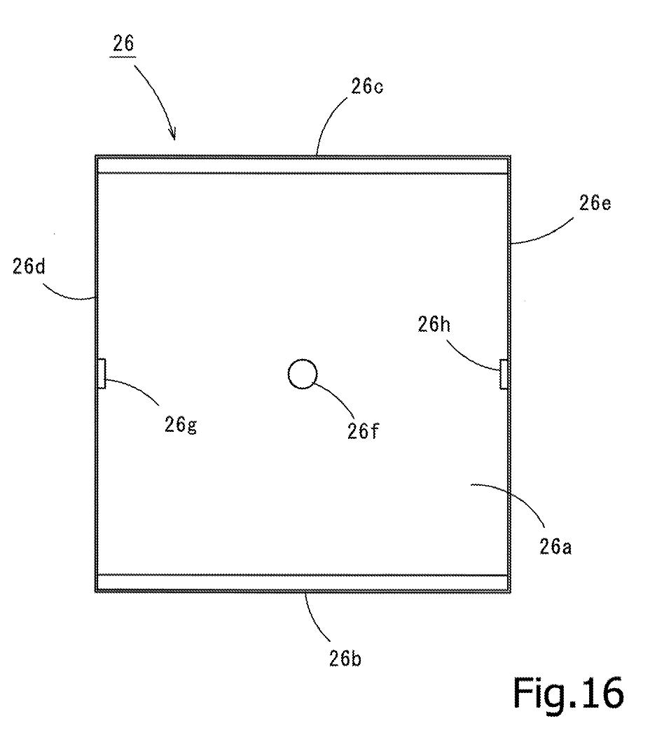

The bottom panel member 26 that composes the case body 21 has, as illustrated in FIG. 15 or FIG. 16, a square-formed bottom panel portion 26a, a front panel portion 26b that rises up from the front of the bottom panel portion 26a, a back panel portion 26c that rises up from the back of the bottom panel portion 26a, a left side panel portion 26d that rises up from the left end of the bottom panel portion 26a, and a right side panel portion 26e that rises up from the right end of the bottom panel portion 26a. All of the front panel portion 26b, the back panel portion 26c, the left side panel portion 26d and the right side panel portion 26e have the same height, and forms a frame as a whole. Note that the front panel portion 26b, the back panel portion 26c, the left side panel portion 26d and the right side panel portion 26e are frame parts that composes this invention. At the center of the bottom panel portion 26a, there is formed a cylindrical pipe joint portion 26f that is pivotally inserted into the bottom end of the above-described liquid inflow pipe 23 whose top end is attached to the lower face of the lid plate 22. At the left center of the top face of the bottom panel portion 26a, there is formed a left locking part 26g as illustrated in FIG. 16, and at the right center of the top face of the bottom panel portion 26a, there is formed a right locking part 26h. The left locking part 26g is a part to which the bottom edge of the left side panel 31 is engaged when the left side panel 31 described later is vertically suspended, so as to keep the suspended posture of the left side panel 31 without allowing it to turn inside the case body 21. The right locking part 26h is a part to which the bottom edge of the right side panel 32 is engaged when the right side panel 32 described later is vertically suspended, so as to keep the suspended posture of the right side panel 32 without allowing it to turn inside the case body 21.

On the front side of the left side panel portion 26d, there is formed an unillustrated ninth shaft insertion hole into which a ninth pivoting shaft 28d (see FIG. 13 or FIG. 20) formed at the left lower end side of the later-described lower front panel 28 is inserted. On the back side of the left side panel portion 26d, there is formed a tenth shaft insertion hole (symbol not assigned) into which a tenth pivoting shaft 30d formed at the left lower end side of the later-described lower back panel 30 is inserted. On the front side of the right side panel portion 26e, there is formed an unillustrated eleventh shaft insertion hole into which the eleventh pivoting shaft 28e (see FIG. 13 or FIG. 12) formed at the right lower end side of the later-described lower front panel 28 is inserted. On the back side of the right side panel portion 26e, there is formed an unillustrated twelfth shaft insertion hole into which the twelfth pivoting shaft 30e formed at the right lower end side of the later-described lower back panel 30 is inserted.

The upper front panel 27 has, as illustrated in FIG. 13, an upper front panel portion 27a formed into a laterally oblong rectangle, an upper left upright panel portion 27b that rises up from the left end of the upper front panel portion 27a towards the front, and an upper right upright panel portion 27c that rises up from the right end of the upper front panel portion 27a towards the front. On the left side face on the top end side of the left upright panel portion 27b, there is provided a first pivoting shaft 27d so as to stand thereon. The first pivoting shaft 27d is a portion to be inserted into the first shaft insertion hole. On the right side face on the top end side of the right upright panel portion 27c, there is provided a second pivoting shaft 27e so as to stand thereon. The second pivoting shaft 27e is a portion to be inserted into the second shaft insertion hole (see FIG. 10). FIG. 13 illustrating these components shows the upper front panel 27 and the lower front panel 28, meanwhile FIG. 15 shows a symmetrical arrangement of the upper back panel 29 and the lower back panel 30, with respect to the upper front panel 27 and the lower front panel 28. Hence, also the upper back panel 29 has formed thereon an upper back panel portion 29a, a upper left upright panel portion 29b, and an upper right upright panel portion 29c, wherein the upper left upright panel portion 29b has formed thereon the third pivoting shaft 29d (see FIG. 20) described previously, and the upper right upright panel portion 29c has formed thereon the fourth pivoting shaft 29e (see FIG. 10) described previously. The third pivoting shaft 29d is a portion to be inserted into the third shaft insertion hole formed in the frame member 25, and the fourth pivoting shaft 29e is a portion to be inserted into the fourth shaft insertion hole formed in the frame member 25.

The lower front panel 28 has, as illustrated in FIG. 13, a lower front panel portion 28a that is formed into the same geometry as the upper front panel portion 27a, a lower left upright panel portion 28b that rises up from the left end of the lower front panel portion 28a towards the front, and a lower right upright panel portion 28c that rises up from the right end of the lower front panel portion 28a towards the front. On the left side face on the bottom end side of the lower left upright panel portion 28b, there is provided a ninth pivoting shaft 28d so as to stand thereon. The ninth pivoting shaft 28d is a portion to be inserted into the ninth shaft insertion hole formed in the left side panel portion 26d that composes the bottom panel member 26. On the right side face on the bottom end side of the lower right upright panel portion 28c, there is provided an eleventh pivoting shaft 28e so as to stand thereon. The eleventh pivoting shaft 28e is a portion to be inserted into an eleventh shaft insertion hole formed in the right side panel portion 26e that composes the bottom panel member 26.

The upper back panel 29 and the lower back panel 30 are, as illustrated in FIG. 12 or FIG. 15, arranged symmetrically with respect to the upper front panel 27 and the lower front panel 28. The upper back panel 29 has the upper back panel portion 29a (see FIG. 15), the upper left upright panel portion 29b (see FIG. 20) that rises up from the left end of the upper back panel portion 29a towards the rear, and the upper right upright panel portion 29c (see FIG. 15) that rises up from the right end of the upper back panel portion 29a towards the rear. On the left side face on the top end side of the upper left upright panel portion 29b, there is provided the third pivoting shaft 29d (see FIG. 20) so as to stand thereon. On the right side face on the top end side of the upper right upright panel portion 29c, there is provided the fourth pivoting shaft 29e (see FIG. 12) so as to stand thereon. The third pivoting shaft 29d is a portion to be inserted into the third shaft insertion hole, and the fourth pivoting shaft 23e is a portion to be inserted into the fourth shaft insertion hole. The lower back panel 30 has a lower back panel portion 30a (see FIG. 15), a lower left upright panel portion 30b ( see FIG. 20) that rises up from the left end of the lower back panel portion 30a towards the rear, and a lower right upright panel portion 30c (see FIG. 12) that rises up from the right end of the lower back panel portion 30a towards the rear. On the left side face on the bottom end side of the lower left upright panel portion 30b, there is provided the tenth pivoting shaft 30d (see FIG. 20) so as to stand thereon. On the right side face of the lower right upright panel portion 30c on the bottom end side, there is provided the twelfth pivoting shaft 30e (see FIG. 12) so as to stand thereon. The tenth pivoting shaft 30d is a portion to be inserted into the tenth shaft insertion hole formed in the left side panel portion 26d of the bottom panel member 26, and the twelfth pivoting shaft 30e is a portion to be inserted into the twelfth shaft insertion hole formed in the right side panel portion 26e of the bottom panel member 26.

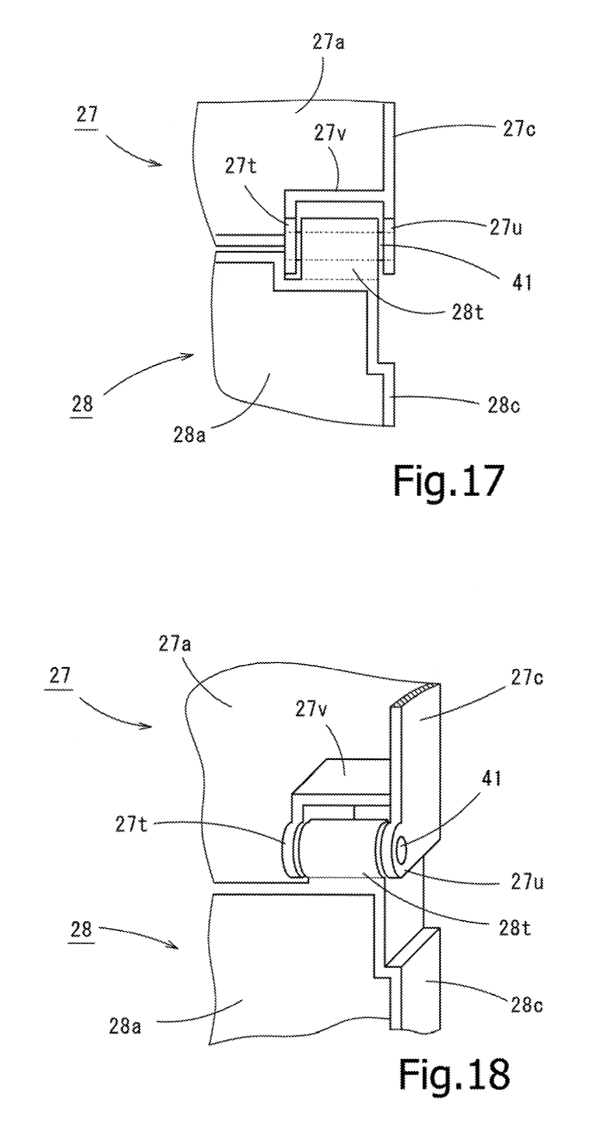

The above-described upper front panel 27 and the lower front panel 28 are, as illustrated in FIG. 13 or FIG. 14, pivotally connected to each other, and also the upper back panel 29 and the lower back panel 30 are pivotally connected to each other. The connection structure between the upper front panel 27 and the lower front panel 28 is same as the connection structure between the upper back panel 29 and the lower back panel 30, and the upper front panel 27 and the lower front panel 28 are connected to each other on the left and right sides. The description below will therefore deal with the connection structure between the right side of the upper front panel 27 and the right side of the lower front panel 28. As enlarged illustrated in each of FIG. 17 and FIG. 18, at the right top end of the lower front panel portion 28a that composes the lower front panel 28, there is provided a horizontally oblong cylindrical part 28t so as to protrude upward from the top edge of the lower front panel portion 28a, and the cylindrical part 28t has, formed at the center thereof, an insertion space through which a pivoting shaft 41 is inserted. Meanwhile, at the right lower corner of the upper front panel portion 27a that composes the upper front panel 27, there are provided a left-supporting panel portion 27t that opposes the left end face of the cylindrical part 28t and supports the left end of the pivoting shaft 41; and a right-supporting panel portion 27u that supports the right end of the pivoting shaft 41, which are faced to each other. A part of the right-supporting panel portion 27u has one bulged part (symbol not assigned) that arched bulges at the lower end side of the upper right upright panel portion 27c further beyond the front end thereof. Meanwhile, the left-supporting panel portion 27t has the other bulged part (symbol not assigned) whose base originates at the end of an intermediate panel portion 27v that extends leftward from a middle part in the lower end portion of the upper right upright panel portion 27c, and bulges in the same geometry with the arched-bulged one bulged part. Each of the one and the other bulged parts has, at the center thereof, a circular through-hole (symbol not assigned) through which the pivoting shaft 41 is inserted. Such connection structure is formed also on the left sides of the upper front panel 27 and the lower front panel 28, and even also on the left and right sides of the upper back panel 29 and the lower back panel 30.

The left side panel 31 is arranged, as illustrated in FIG. 19, on the left side of the case body 21, and has a square-formed left side panel body 31a, the front panel portion 31b that is formed on the front side of the left side panel body 31a and rises up therefrom towards the left, and an unillustrated back panel portion that is formed in the rear side of the left side panel body 31a and rises up therefrom towards the left. At a middle portion on the top end side of the front panel portion 31b, there is provided a fifth pivoting shaft 31d (see FIG. 19) so as to stand on the front side thereof. Meanwhile, at a middle portion on the top end side of the back panel portion, there is provided an unillustrated sixth pivoting shaft so as to stand on the rear side thereof. The fifth pivoting shaft 31d is a portion to be inserted in the fifth shaft insertion hole formed in the frame member 25 described previously, and the sixth pivoting shaft is a portion to be inserted into the sixth shaft insertion hole.

The right side panel 32 is disposed, as illustrated in FIG. 12 or FIG. 19, in the right part of the case body 21, and has a square-formed right side panel body 32a, a front panel portion 32b that is formed on the front side of the right side panel body 32a and rises up therefrom towards the right, and a back panel portion 32c that is formed on the rear side of the right side panel body 32a and rises up therefrom towards the right. At a middle portion on the top end side of the front panel portion 32b, there is provided the seventh pivoting shaft 32d (see FIG. 10) so as to stand on the front side thereof. At a middle portion on the top end side of the back panel portion 32b formed in the right side panel 32, there is provided the unillustrated eighth pivoting shaft 32e formed on the rear side of the back panel portion. The seventh pivoting shaft 32d is a portion to be inserted into the seventh shaft insertion hole formed in the above-described frame member 25, meanwhile the eighth pivoting shaft 32e is a portion to be inserted into the eighth shaft insertion hole.

At the center of the lid plate 22, there is formed a circular opening 22a as illustrated in FIG. 10. The opening 22a is a portion to which an end of an unillustrated hose or tube, or pipe is inserted or connected, and through which a pre-filtered liquid comes in. At the center of the lower face of the lid plate 22, there is fixed the top end of the liquid inflow pipe 23 that communicates with the opening 22a, and has an inner diameter larger than the diameter of the opening 22a. the liquid inflow pipe 23 has a length, as illustrated in FIG. 15, slightly shorter than the distance between the lower face of the lid plate 22 and the top face of the bottom panel portion 26a. The liquid inflow pipe 23 has a plurality of unillustrated drain holes through which the liquid, having introduced therein, can be discharged outside the liquid inflow pipe 23. Hence the liquid can flow through these drain holes into the liquid-receiving space 3d of the filter 3 housed in the case body 21.

The liquid inflow pipe 23 has a plurality of spacers 45 fixed to the outer circumference thereof. The spacers 45 are plates formed to have the same shape, that is, formed to have a square shape conforming to the planer shape of the liquid-receiving space 3d formed in the filter illustrated in FIG. 2, and is formed to have an outer shape allowed for insertion into the liquid-receiving space 3d from the top thereof. Note that the individual sides of these plurality of spacers 45 lie 45° away from the individual sides of the lid plate 22 around the center of the liquid inflow pipe 23. Hence, as described later, the liquid inflow pipe 23 is inserted while heading the lower end thereof, together with the spacers 45, into the liquid-receiving space 3d, from above the filter 3 housed in the case body 21, with the lid plate 22 turned 45°.

The distance between the lower face of the lid plate 22 and a spacer 45A, which is fixed closest to the lower face of the lid plate 22 among the plurality of spacers 45, is determined so that the topmost valley part 3b out of the plurality of valley parts 3b formed in the above-described filter 3, or two valley parts 3b, 3b including such topmost valley part 3b and the valley part 3b just below it, can reside close to the outer circumference of the liquid inflow pipe 23. On the other hand, the distance between the top face of the bottom panel portion 26a that composes the bottom panel member 26 and a spacer 45B, which is fixed closest to the top face of the bottom panel portion 26a among the plurality of spacers 45, is determined so that the lowermost valley part 3b out of the plurality of valley parts 3b formed in the above-described filter 3, or two valley parts 3b, 3b including such lowermost valley part 3b and the valley part 3b just above it, can reside close to the outer circumference of the liquid inflow pipe 23.

The filter 3 and the filter case 2 that compose the liquid filtration apparatus 1 of this embodiment have been described. The description below will deal with, in sequence, a method of disassembling the filter case 2, and collapsing the case body 21; and a method of housing a plurality of filters 3 in the finished filter case 2, and then fixing the lid plate 22.

The description will now begin with the method of disassembling the finished filter case 2. As illustrated in FIG. 1, the filter case 2 in the finished form as the liquid filtration apparatus 1 is disassembled by detaching the lid plate 22 having been fixed to the top face of the frame member of the case body 21 at four positions using unillustrated screws, then by turning the lid plate 22 by 45°, and moving the lid plate 22 upward. By such procedure, the liquid inflow pipe 23 and the plurality of spacers 45, having been inserted into the liquid-receiving space 3d of the filter 3, may be detached. Next, the plurality of filters 3 are taken, out from the case body 21. Note that the lid plate 22 and the filters 3 may alternatively be taken out without turning the lid plate 2, but by lifting it up together with the filters 3, and then by turning the lid plate 22 by 45°, to thereby detach the liquid inflow pipe 23 and the plurality of spacers 45 from the plurality of filters 3. The filters 3 thus taken out may be washed using washing water or the like, after disconnecting the filters 3, and unfolding the individual filters 3 as illustrated in FIG. 5.

Meanwhile, the case body 21 from which the filters 3 were detached may be collapsed by pressing the lower end side of the right side panel 32 inwardly into the case body 21, and by swinging the right side panel 32 clockwise in FIG. 19, around the seventh pivoting shaft 32d and the eighth pivoting shaft 32e. This procedure disengages the lower end side of the right, side panel 32 from the right locking part 26h illustrated in FIG. 16. This procedure also disengages the lower end of the left side panel 31 from the left locking part 26g illustrated in FIG. 16. By further turning the left side panel 31 counterclockwise, the right side panel 32 will further be turned clockwise, with the lower end thereof brought into contact with the inner face of the left side panel 31, and kept in slide contact with the inner face of the left side panel 31. The right side panel 32 will finally be housed in the upper portion of the frame member 25 as illustrated in FIG. 20, and the left side panel 31 will be housed below the right side panel 32. This way of housing the right side panel 32 in the upper side in the frame member 25 and the left side panel 31 so as to be stacked below the right side panel 32 is enabled because, as illustrated in FIG. 19, the seventh pivoting shaft 32d and the eighth pivoting shaft 32e, around which the right side panel 32 swings, are positioned above the position of the fifth pivoting shaft 31d and the sixth pivoting shaft, around which the left side panel 31 swings.

Upon pressing, as illustrated in FIG. 20, so as to bring a joint between the upper front panel 27 and the lower front panel 28 in proximity to a joint between the upper back panel 29 and the lower back panel 30, the upper front panel 27 turns around the first pivoting shaft 27d and the second pivoting shaft 27e inwardly into the case body 21; the lower front panel 28 turns around the ninth pivoting shaft 28d and the eleventh pivoting shaft 28e inwardly into the case body 21; and the upper front panel 27 and the lower front panel 28 move in an articulated manner around the pivoting shaft 41. Meanwhile, upon pressing the joint between the upper back panel 29 and the lower back panel 30 so as to move it inwardly into the case body 21, the upper back panel 29 turns around the third pivoting shaft 29d (see FIG. 10) and the fourth pivoting shaft 29e (see FIG. 12) inwardly into the case body 21; the lower back panel 30 turns around the tenth pivoting shaft 30d and the twelfth pivoting shaft 30e inwardly into the case body 21; and the upper back panel 29 and the lower back panel 30 move in an articulated manner around a portion corresponded to the pivoting shaft 41. Both of the thus folded upper front panel 27 and the upper back panel 29 are retracted as illustrated in FIG. 21 or FIG. 22, within the frame member 25 and below the left side panel 31; and both of the lower front panel 28 and the lower back panel 30 are retracted, above the bottom panel portion 26a and within a portion formed to have a frame shape as a whole. Hence, the thus collapsed case body 21 will have a capacity far smaller than that of the case body 21 in the state illustrated in FIG. 12. Between the thus folded lower front panel 28 and the lower back panel 30, there is the pipe joint portion 26f fixed to the center of the bottom panel portion 26a.

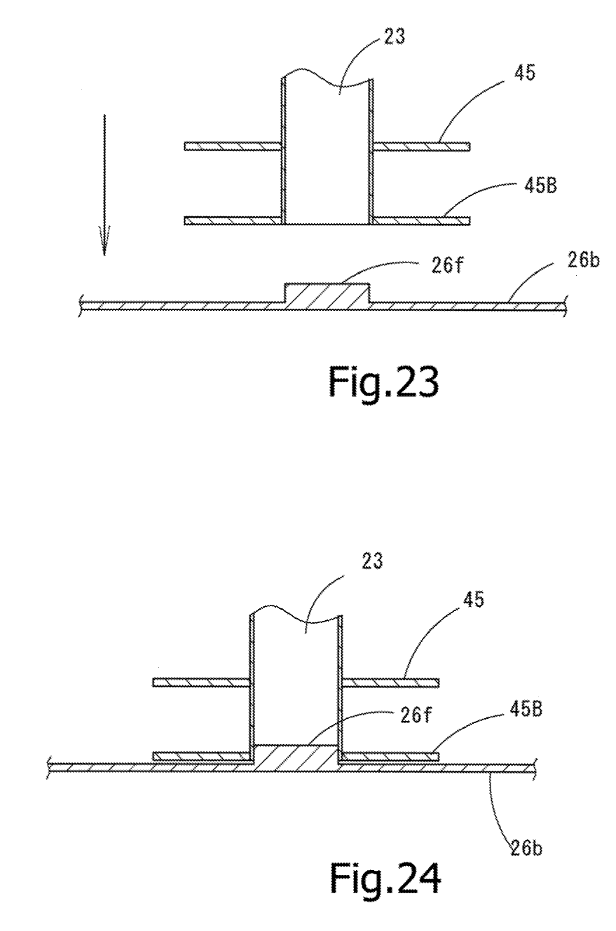

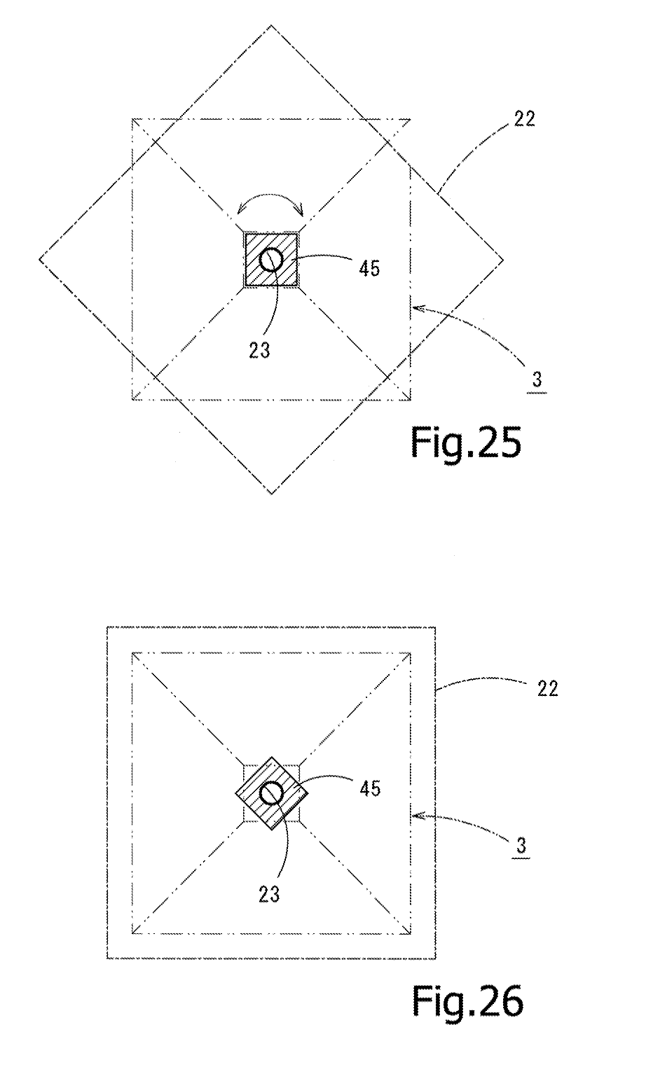

As illustrated in FIG. 21 or FIG. 22, when the thus collapsed case body 21 is used again in the form of liquid filtration apparatus 1 as illustrated in FIG. 1, the procedures of collapsing the case body 21 are followed in a completely reversed order, so as to reach the state illustrated in FIG. 10 or FIG. 11. Into the thus restored, case body 21 as illustrated in FIG. 10 or FIG. 11, a plurality of filters 3 that are connected while placing the connection tab 3c in between are housed. The lid plate 22 is then held above the filter 3, being turned 45° relative to the outer contour of the filter as illustrated in FIG. 25, and the liquid inflow pipe 23 is then inserted, while heading the lower end thereof, from above the filter 3 into the liquid-receiving space 3d, to thereby insert the spacers 45 into the liquid-receiving space 3d. After bringing the liquid inflow pipe 23 down to the position illustrated in FIG. 23, and then as illustrated in FIG. 24, the cylindrical pipe joint portion 26f fixed to the center of the bottom panel portion 26a is inserted into the lower end portion of the liquid inflow pipe 23. Upon completion of these procedures, the lid plate 22 is turned 45°. As a result of such turning of the lid plate 22, four sides of the square-formed filter 3 and four sides of the lid plate 22 (and four sides of the bottom panel portion 26a) are aligned parallel to each other as illustrated in FIG. 26, and the individual spacers 45 are kept turned 45° relative to the liquid-receiving space 3d formed in the filter 3. Note that the filter 3 is not illustrated in FIG. 23 and FIG. 24.

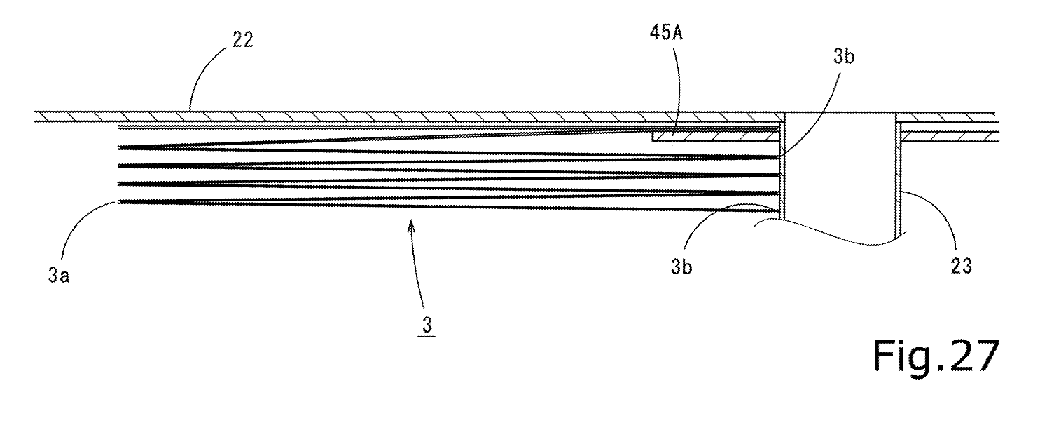

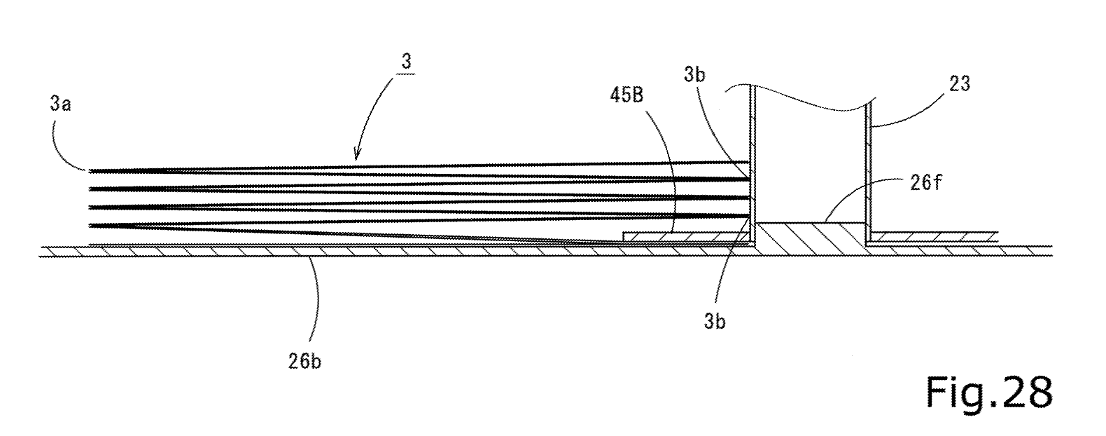

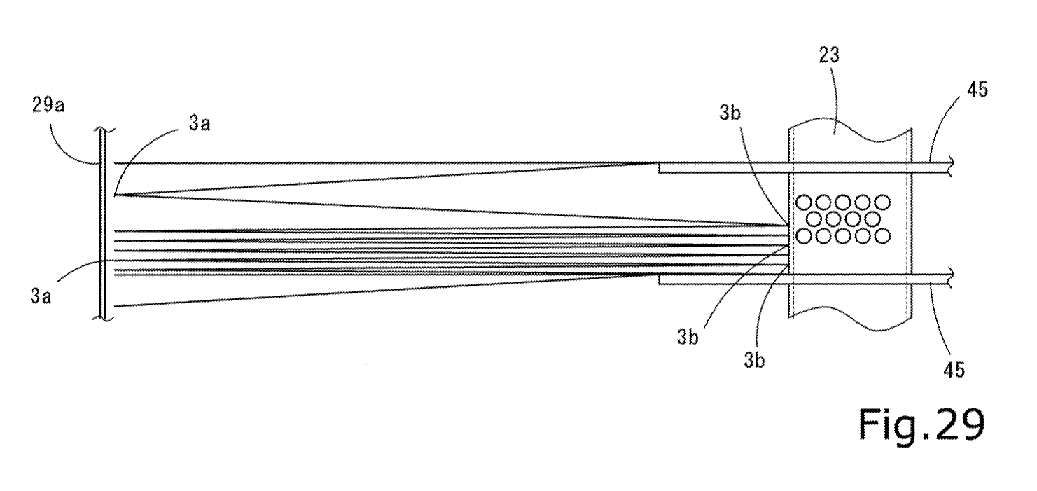

When the lid plate 22 is turned 45° four corners of the spacer 45A, fixed closest to the lower face of the lid plate 22, shift towards the ridge part 3a away from the topmost valley part 3b of the filter 3 (or towards the ridge part 3a away from the valley part 3b formed below the topmost valley part 3b) as illustrated in FIG. 27, thereby holding the top inner circumferential portion of the filter 3 between the lower face of the lid plate 22 and the top face of the spacer 45A. Concurrently, when the lid plate 22 is turned 45°, four corners of the spacer 45B, fixed closest to the top face of the bottom panel portion 26a, shift towards the ridge part 3a away from the lowermost valley part 3b of the filter 3 (or towards the ridge part 3a away from the valley part 3b formed above the lowermost valley part 3b) as illustrated in FIG. 28, thereby holding the lowermost inner circumferential portion of the filter 3 between the top face of the bottom panel portion 26a and the lower face of the spacer 45B. Also when the lid plate 22 is turned 45° as illustrated in FIG. 29, the individual spacers 45 arranged between the spacer 45A and the spacer 45B shift towards the ridge parts 3a away from the valley parts 3b formed in the middle of the filter 3, wherein every vertically adjacent spacers 45, 45 hold several valley parts 3b in between. Every middle section of the filter 3, which falls between the vertically adjacent spacers 45, 45 in this state of filter 3, is kept with their individual ridge parts 3a and the valley parts 3b brought in close proximity due to the self-weight, as illustrated in FIG. 29.

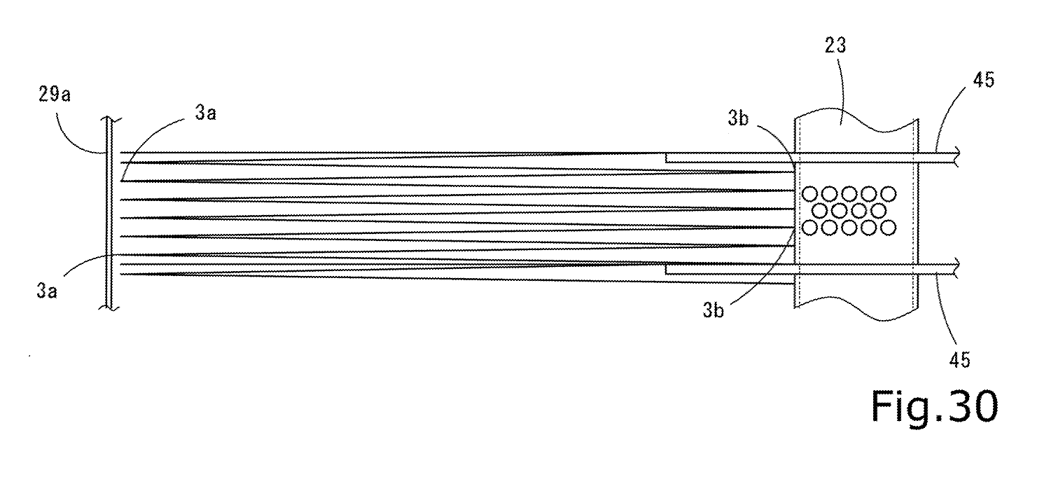

Upon completion of such procedures for turning the lid plate 22 by 45°, the lid plate 22 is fastened with unillustrated screws to the top face of the frame member 25, to thereby complete the liquid filtration apparatus 1 described at the beginning. In the thus completed liquid filtration apparatus 1, an unillustrated liquid that is input through the opening 22a formed in the lid plate 22 into the liquid inflow pipe 23 flows through the drain holes formed in the liquid inflow pipe 23, and then enters the liquid-receiving space 3d formed at the center of the filter 3. Upon input of the liquid, the ridge parts 3a and valley parts 3b having been kept in close proximity are spaced from each other as illustrated in FIG. 30, since the liquid comes into every space between the vertically adjacent ridge parts 3a, 3a as driven by inflow pressure of the liquid. As a consequence, the liquid comes out through the filter 3 from every space between the adjacent ridge parts 3a, 3a, while leaving any foreign matters having been contained in the liquid trapped within the filter in the output process.

Since every vertically juxtaposed filters 3 are connected by the connection tab 3c formed at the top edge of each filter as illustrated in FIG. 8, and since the connection tab 3c surrounds the circumference of the lower end side of the superposed filter 3, so that the liquid will not be output from between the filters 3, 3, to the outside of the filter case 2. Since the top end side of the topmost filter 3 is held between the top most spacer 45A and the lid plate 22, so that the unfiltered liquid will not be output from between the top portion of the filter 3 and the lower face of the lid plate 22 to the outside of the filter case 2. Also since the lower end side of the bottommost filter 3 is held between the bottommost spacer 45B and the bottom panel portion 26a, so that the unfiltered liquid will again not be output from between the bottom portion of the filter 3 and the top face of the bottom panel member 26 to the outside of the filter case 2.

In short, owing to the structure employed so as to make the spacer 45A and the lid plate 22 hold the top end side of the filter 3 in between, and so as to make the spacer 45B and the bottom panel portion 26a hold the lower end side of the filter 3 in between; and owing to the structure employed so as to connect the vertically juxtaposed filters 3 with the connection tab 3c, the liquid filtration apparatus 1 is now able to prevent the unfiltered liquid from leaking out from the t op and bottom end s ides of the filter 3 housed in the filter case 2, and from between the mutually connected filters 3, 3 to the outside of the filter case 2. According to such employment of these structures, the liquid filtration apparatus 1 is now also able to reduce the volume and capacity (volume reduction) as a whole, typically during transportation.

Since the filter 3 has the individual ridge parts 3a and the valley parts 3b whose longitudinal directions are laid in the direction orthogonal to the height direction of the filter 3, so that the liquid filtration apparatus 1 can house a larger number of filters 3 per unit volume, as compared with any filter having the ridge parts and so forth laid in the height direction. As a consequence, the liquid filtration apparatus 1 can achieve a high level of filtration performance. Since in particular the filter 3 can be unfolded into a rectangular sheet body 5, so that the filter 3 can be taken out from the filter case 2, washed to remove any foreign matter adhered to the inner face thereof, re-folded into the filter 3, re-housed in the case body 21, and can be used in the liquid filtration apparatus 1, making it most economical.

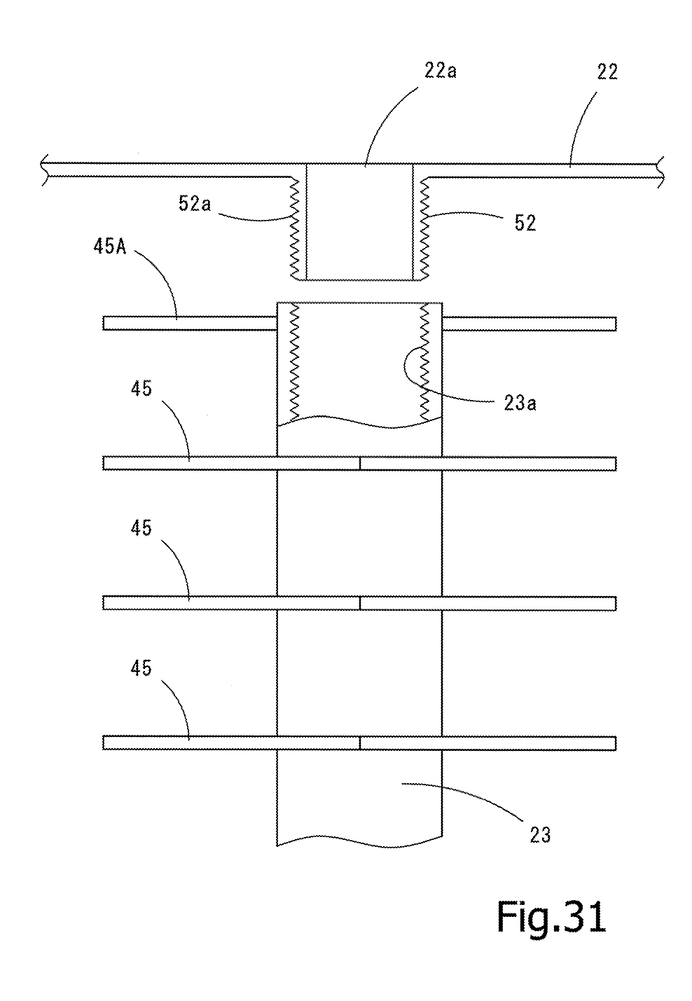

While the liquid inflow pipe 23 of the liquid filtration apparatus 1 according to the above-described embodiment has been fixed at the top end thereof to the lower face of the lid plate 22, the liquid inflow pipe 23 that composes this invention may alternatively be detachable from the lower face of the lid plate 22 as illustrated in FIG. 31. More specifically, on the lower face of the lid plate 22 illustrated in FIG. 31, there is a connecting post 52 having one thread 52a on the outer circumference, fixed at the top end thereof. The liquid inflow pipe 23 has the other thread 23a threaded on the inner circumference so as to be screw tighten with the one screw 52a. The connecting post 52 communicates with the opening 22a formed at the center of the lid plate 22, and has the inner diameter same as the diameter of the opening 22a. By making the lid plate 22 and the liquid inflow pipe 23 detachable from each other as described above, the lid plate 22 and the liquid inflow pipe 23 are separable when the liquid filtration apparatus 1 is disassembled. Hence, it now becomes possible to transport, house and store a larger number of filter cases per unit capacity, not only during transportation, but also during storage.

In the case body 21 that composes the liquid filtration apparatus 1 of the above-described embodiment, each of connection structures that connects the upper front panel 27 to the frame member 25, that connects the upper back panel 29 to the frame member 25, that connects the lower front panel 28 to the bottom panel member 26, that connects the lower back panel 30 to the bottom panel member 26, that connects the left side panel 31 to the frame member 25, and that connects the right side panel 32 to the frame member 25 is composed of a pivoting shaft (symbol not assigned), represented by the first pivoting shaft 27d, and an insertion hole (symbol not assigned) through which the pivoting shaft is inserted. The connection may, however, have any alternative structure so long it swingably connects the left side panel 31 to the frame member 25, such as connecting them using a hinge.

In the case body 21 that composes the liquid filtration apparatus 1 of the above-described embodiment, the front panel is halved into the upper front panel 27 and the lower front panel 28, and similarly the back panel is halved into the upper back panel 29 and the lower back panel 30. The case body 21 may, however, be composed of a single front panel or a single back panel, rather than such halved panels.

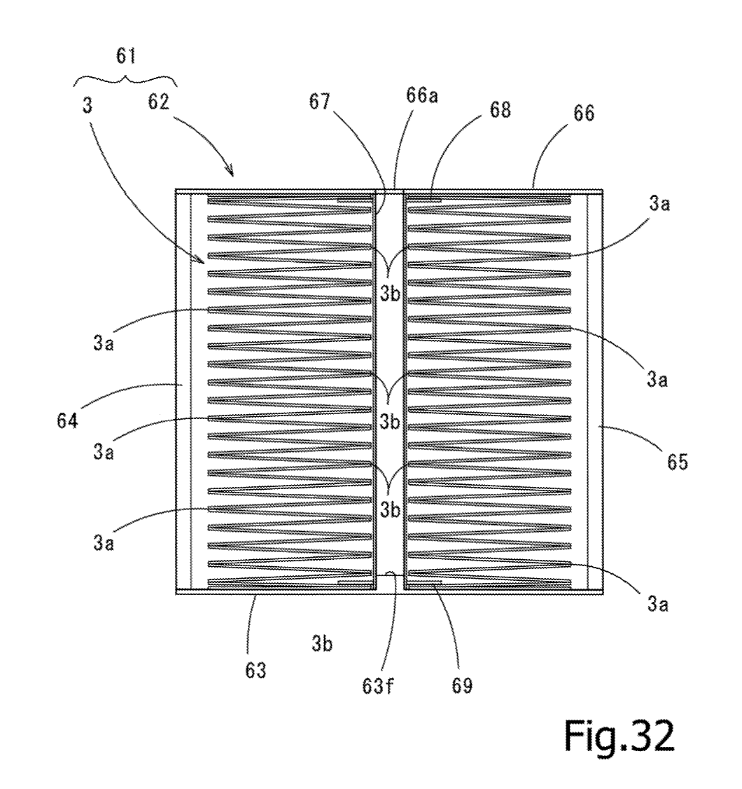

While the above-described liquid filtration apparatus 1 has the filter 3 housed in the collapsible filter case 2, the liquid filtration apparatus of this invention may be a liquid filtration apparatus 61 (a liquid filtration apparatus of a second embodiment) illustrated in FIG. 32, having the filter 3 housed in a non-collapsible filter case 62. The liquid filtration apparatus 61 has a filter case 62, and a filter 3 housed in the filter case 62. The filter 3 is configured in the same way as the filter 3 described previously. The filler case 62 has a square-formed bottom plate 63; a left side panel 64 and a right side panel 65 that rise up from the ends of the bottom plate 63; an unillustrated front panel and a back panel; and a lid plate 66 that closes the filter housing space (symbol not assigned) specified by the left side panel 64, the right side panel 65 and the unillustrated front panel and the back panel, and is detachably attached to the top faces of the left side panel 64, the right side panel 65 and the unillustrated front panel and the back panel, using fixing means such as unillustrated screws. Each of the left side panel 64, the right side panel 65, and the unillustrated front panel and the hack panel has a large number of unillustrated outer through-holes through which the filtrate is discharged.

At the center of the top face of the bottom plate 63, there is formed a cylindrical pipe joint portion 63f. Meanwhile, at the center of the lid plate 66, there is formed a circular opening 66a. The opening 66a is a portion into which the end of an unillustrated hose or tube is inserted or connected, and through which a pre-filtered liquid comes in. At the center of the lower face of the lid plate 66, there is fixed the top edge of a liquid inflow pipe 67 that communicates with the opening 66a, and has an inner diameter larger than the inner diameter of the opening 66a. The liquid inflow pipe 67 has a length slightly shorter than the distance between the lower face of the lid plate 66 and the top face of the bottom plate 63. The liquid inflow pipe 67 has a plurality of unillustrated drain holes through which the liquid, having introduced therein, can flow outside the liquid inflow pipe 67.

On the outer circumference on the top end side of the liquid inflow pipe 67, there is fixed the base of an upper spacer 68, meanwhile on the outer circumference on the bottom end side of the liquid inflow pipe 67, there is fixed a lower spacer 69. The upper spacer 68 and the lower spacer 69 have shapes same as that of the spacer 45 illustrated in FIG. 25 and FIG. 26, and the positional relation with the lid plate 66 is also same as that between the lid plate 22 and the spacer 45 described previously. The upper spacer 68 has the same design as the spacer 45A illustrated in FIG. 27, wherein each of the four corners formed in the upper spacer 68 shifts towards the ridge part 3a away from the topmost valley part 3b of the filter 3 (or towards the ridge part 3a away from the valley part 3b formed below the topmost valley part 3b), thereby holding the topmost inner circumferential portion of the filter 3 between the lower face of the lid plate 66 and the top face of the upper spacer 68. Meanwhile the lower spacer 69 has the same design as the spacer 45B illustrated in FIG. 28, wherein each of the four corners formed in the lower spacer 69 shifts towards the ridge part 3a away from the lowermost valley part 3b of the filter 3 (or towards the ridge part 3a away from the valley part 3b formed above the lowermost valley part 3b), thereby holding the lowermost inner circumferential portion of the filter 3 between the top face of the bottom plate 63 and the bottom face of the lower spacer 69.

Also the liquid filtration apparatus 61 of the second embodiment described above is reusable, after detaching the lid plate 66, taking the filter 3 out from the filter case 62, cleaning the filter 3, and putting it back again in the filter case 62.

### REFERENCE SIGNS LIST

1 liquid filtration apparatus
2 filter case
3 filter
3a ridge part
3b valley part
3c connection tab
3d liquid-receiving space
3h overlap margin
5 sheet body
21 case body
22 lid plate
22a opening
23 liquid inflow pipe
25 frame member
26 bottom panel member
27 upper front panel
28 lower front panel
29 upper back panel
30 lower back panel
31 left side panel
32 right side panel
45 spacer
61 liquid filtration apparatus
62 filter case
63 bottom plate
64 left side panel
65 right side panel
66 lid plate
66a opening
67 liquid inflow pipe
68 upper spacer
69 lower spacer

1. A liquid filter comprising:
a liquid-receiving space into which a liquid flows, formed at the center;
a plurality of ridge parts each extended in the direction orthogonal to the height direction, and vertically juxtaposed so as to he exposed individually to the front, back, left side and right side; and
a plurality of valley parts each formed on the sides opposite to the individual positions of formation of the ridge parts, each extended in the direction orthogonal to the height direction, and vertically juxtaposed so as to form a part of the liquid-receiving space,
being unfoldable from a folded state into a rectangular sheet body, and
the sheet body in the folded state having its left end and right end overlapped at any position selected from, the front, back, left side and right side.

2. The liquid filter according to claim 1, wherein the sheet body has, either on its left end or right end, slits individually formed at portions where the valley parts are formed, each of these slits having a length shorter than the length of overlap margin of the left end and the right end of the sheet body.

3. The liquid filter according to claim 1 or 2, having formed either on the top edge or the bottom edge thereof, a connection tab that connects a particular liquid filter at the bottom edge or at the top edge thereof, with the other liquid filter disposed on the upper or lower side of the particular liquid filter, so as to prevent the liquid from leaking out through a portion between the particular liquid filter and the other liquid filter before being filtered.

4. The liquid filter according to claim 3, wherein
the connection tab is disposed above the topmost ridge part that is formed at the topmost position of the plurality of ridge parts of the particular liquid filter, the particular liquid filter and the other liquid filter being connected in such a way that the topmost ridge part is disposed outside the lowermost ridge part that is formed at the lowermost position of the plurality of ridge parts of the other liquid filter disposed on the upper side of the particular liquid filter; or,
the connection tab is disposed below the lowermost ridge part that is formed at the lowermost position of the plurality of ridge parts of the particular liquid filter, the particular liquid filter and the other liquid filter being connected in such a way that the lowermost ridge part is disposed outside the topmost ridge part that is formed at the topmost position of the plurality of ridge parts of the other liquid filter disposed on the lower side of the particular liquid filter,
being unfoldable from a folded state into a rectangular sheet body, inclusive of the connection tab.

5. A liquid filtration apparatus comprising:
a filter case comprising:
a rectangular-shaped bottom plate;
a rectangular-shaped lid plate, with the lower face opposed to the top face of the bottom plate, and with a circular liquid inlet opening formed at the center;
a filter case having four side plates arranged between the bottom plate and the lid plate; and
the liquid filter described in any one of claims 1 to 4, housed in a space that is surrounded by the bottom plate, the lid plate and the four side plates,
each side plate having an outer opening through which a filtrate is output,
the lid plate being detachably attached to the side plates, having fixed at the center thereof the top end of the liquid inflow pipe body that communicates with the liquid inlet opening, and is inserted into the liquid-receiving space formed in the liquid filter, and
the liquid inflow pipe body having a plurality of inner openings through which a pre-filtered liquid is output.

6. The liquid filtration apparatus according to claim 5, wherein the liquid inflow pipe body has fixed on the outer circumference thereof a plurality of plate-like spacers arranged from the topmost part towards the bottommost part, the end portion of each spacer being inserted between a particular valley part formed in the liquid filter and the other valley part adjacent thereto, after inserted into the liquid-receiving space formed at the center of the liquid filter and then turned.

7. The liquid filtration apparatus according to claim 5, wherein the spacer that is fixed at the topmost position, out of the plurality of spacers fixed to the liquid inflow pipe body, has four portions whose top faces are used to hold, jointly with the lower face of the lid plate, the topmost part of the liquid filter on the inner circumferential side, after inserted into the liquid-receiving space and then turned.

8. The liquid filtration apparatus according to claim 6 or 7, wherein the spacer that is fixed at the lowermost position, out of the plurality of spacers fixed to the liquid inflow pipe body, has four portions whose lower faces are used to hold, jointly with the top face of the bottom plate, the bottommost part of the liquid filter on the inner circumferential side, after inserted into the liquid-receiving space and then turned.
